(19) United States
(12) Patent Application Publication
(10) Pub. No.: US 2025/0285286 A1
(43) Pub. Date: Sep. 11, 2025

(54) REGION DETECTION DEVICE AND DEFECT INSPECTION APPARATUS

(71) Applicant: CANON KABUSHIKI KAISHA, Tokyo (JP)

(72) Inventor: YUJI HARA, Tokyo (JP)

(21) Appl. No.: 19/068,111

(22) Filed: Mar. 3, 2025

(30) Foreign Application Priority Data
Mar. 8, 2024 (JP) 2024-036266

(51) Int. Cl. G06T 7/12; G06T 7/00; G06T 7/73

(52) U.S. Cl. CPC G06T 7/12; G06T 7/001; G06T 7/74; G06T 2207/20021; G06T 2207/30121

(57) ABSTRACT

A region detection device for detecting a display region of a display device from an inspection image captured in a state in which the display region is lighted, is provided. The region detection device scans plural lines set to intersect a side forming an outer edge of the display region, and specifies the display region by detecting a coordinate position of each side based on a pixel value of a pixel of each of the plural lines. In the scanning of the plural lines, the region detection device compares each of the pixel values of the pixels included in the plural lines with a threshold, and detect, as the coordinate position, a position in a scanning direction at which all the pixel values of the plural lines change from values smaller than the threshold to values not smaller than the threshold.

### BACKGROUND OF THE INVENTION

### Cross-Reference to Priority Application

This application claims the benefit of Japanese Patent Application No. 2024-036266, filed Mar. 8, 2024, which is hereby incorporated by reference herein in its entirety.

### FIELD OF THE INVENTION

The present disclosure relates to a region detection device and a defect inspection apparatus.

### DESCRIPTION OF THE RELATED ART

There has been proposed a method of analyzing an inspection image obtained by capturing a display device as defect inspection of the display device along with an increase in size and an increase in the number of pixels of a sensor panel mounted on an image capturing apparatus. When performing defect inspection using the inspection image, it is necessary to detect a display region of the display device as an inspection region. Japanese Patent Laid-Open No. 2001-083474 describes that circumscribed regions of portions in which the dark/light values of images obtained by capturing a black video and a white video displayed on a color liquid crystal display panel are different by a predetermined value or more are obtained and set as inspection target regions within the images.

### SUMMARY OF THE INVENTION

In a case where data of an abnormal signal level such as a light spot is recorded outside a captured display region in an inspection image due to a defect of a sensor panel or the like, the edge portion of the display region may be determined erroneously by the operation described in Japanese Patent Laid-Open No. 2001-083474.

Some embodiments of the present disclosure provide a technique advantageous in improving detection accuracy of a display region.

According to some embodiments, a region detection device for detecting a display region of a display device from an inspection image captured in a state in which the display region is lighted, wherein the region detection device is configured to: scan plural lines set to intersect a side forming an outer edge of the display region; and specify the display region by detecting a coordinate position of each side based on a pixel value of a pixel of each of the plural lines, and in the scanning of the plural lines, the region detection device is configured to: compare each of the pixel values of the pixels included in the plural lines with a threshold; and detect, as the coordinate position, a position in a scanning direction at which all the pixel values of the plural lines change from values smaller than the threshold to values not smaller than the threshold, is provided.

Further features of the present invention will become apparent from the following description of exemplary embodiments (with reference to the attached drawings).

### BRIEF DESCRIPTION OF THE DRAWINGS

FIG. 1 is a block diagram showing an example of the configuration of a defect inspection apparatus including a region detection device according to an embodiment;

FIG. 2 is a flowchart illustrating an example of the processing procedure of the defect inspection apparatus shown in FIG. 1;

FIG. 3 is a circuit diagram showing an example of the configuration of the region detection device shown in FIG. 1;

FIG. 4 is a view showing the relationship between a defect of an inspection image and scan lines for scanning the inspection image;

FIG. 5 is a view for explaining the arrangement of the scan lines for scanning the inspection image;

FIG. 6 is a block diagram showing an example of the configuration of the defect inspection apparatus including the region detection device according to the embodiment;

FIG. 7 is a circuit diagram showing an example of the configuration of the region detection device shown in FIG. 6;

FIG. 8 is a view showing the relationship between a defect of an inspection image and scan lines for scanning the inspection image;

FIG. 9 is a view for explaining the arrangement of the scan lines for scanning the inspection image;

FIG. 10 is a block diagram showing an example of the configuration of the defect inspection apparatus including the region detection device according to the embodiment;

FIG. 11 is a flowchart illustrating an example of the processing procedure of the defect inspection apparatus shown in FIG. 10;

FIG. 12 is a circuit diagram showing an example of the configuration of the region detection device shown in FIG. 11;

FIG. 13 is a view for explaining the arrangement of scan lines for scanning an inspection image;

FIG. 14 is a flowchart illustrating an example of the processing procedure of the region detection device shown in FIG. 10;

FIG. 15 is a flowchart illustrating an example of the processing procedure of the region detection device shown in FIG. 10;

FIG. 16 is a flowchart illustrating an example of the processing procedure of the region detection device shown in FIG. 10;

FIG. 17 is a flowchart illustrating an example of the processing procedure of the region detection device shown in FIG. 10;

FIG. 18 is a block diagram showing an example of the configuration of the defect inspection apparatus including the region detection device according to the embodiment;

FIG. 19 is a circuit diagram showing an example of the configuration of the region detection device shown in FIG. 18;

FIG. 20 is a view for explaining the arrangement of scan lines for scanning an inspection image;

FIG. 21 is a flowchart illustrating an example of the processing procedure of the region detection device shown in FIG. 18;

FIG. 22 is a flowchart illustrating an example of the processing procedure of the region detection device shown in FIG. 18;

FIG. 23 is a flowchart illustrating an example of the processing procedure of the region detection device shown in FIG. 18; and

FIG. 24 is a flowchart illustrating an example of the processing procedure of the region detection device shown in FIG. 18.

### DESCRIPTION OF THE EMBODIMENTS

Hereafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

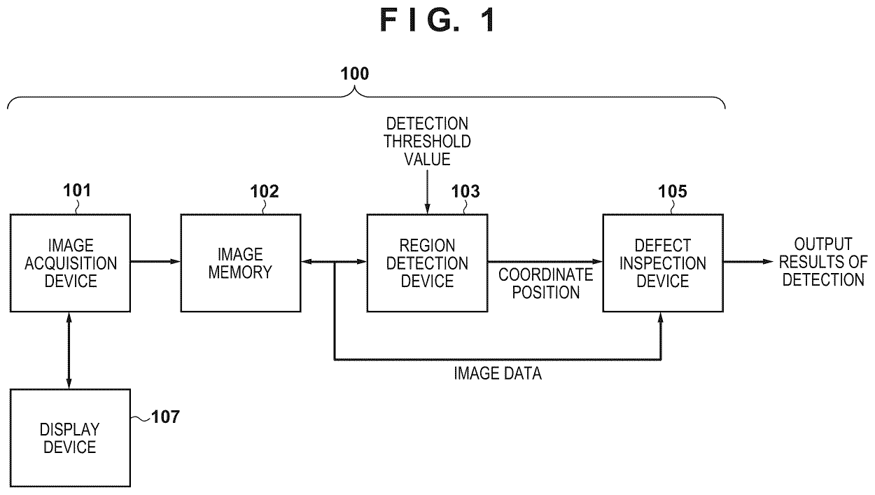

A defect inspection apparatus and a region detection device arranged in the defect inspection apparatus according to an embodiment of the present disclosure will be described with reference to FIGS. 1 to 24. FIG. 1 is a block diagram showing an example of the configuration of a defect inspection apparatus 100 including a region detection device 103 according to this embodiment. The defect inspection apparatus 100 includes an image acquisition device 101, an image memory 102, the region detection device 103, and a defect inspection device 105. The image acquisition device 101 acquires an inspection image of a display device 107 as an inspection target. The image memory 102 stores the image data of the inspection image acquired by the image acquisition device 101. The region detection device 103 detects a display region from the inspection image captured in a state in which the display region of the display device 107 is lighted. A threshold for detecting the display region is input to the region detection device 103. The defect inspection device 105 inspects a defect of the display region specified by the region detection device 103. The defect inspection device 105 outputs an inspection result.

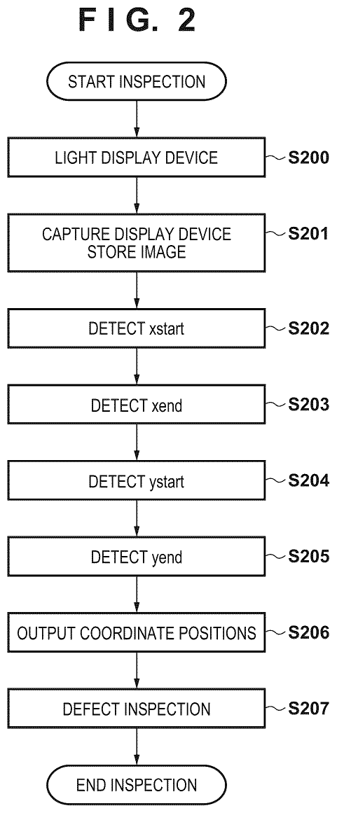

FIG. 2 shows the processing procedure of the defect inspection apparatus 100. First, in step S200, the display device 107 is set in a lighting state. For example, in accordance with a signal output from the image acquisition device 101, the display device 107 may display a white image. Next, in step S201, the image acquisition device 101 acquires an inspection image by capturing the display device 107. The image data of the acquired inspection image is stored in the image memory 102.

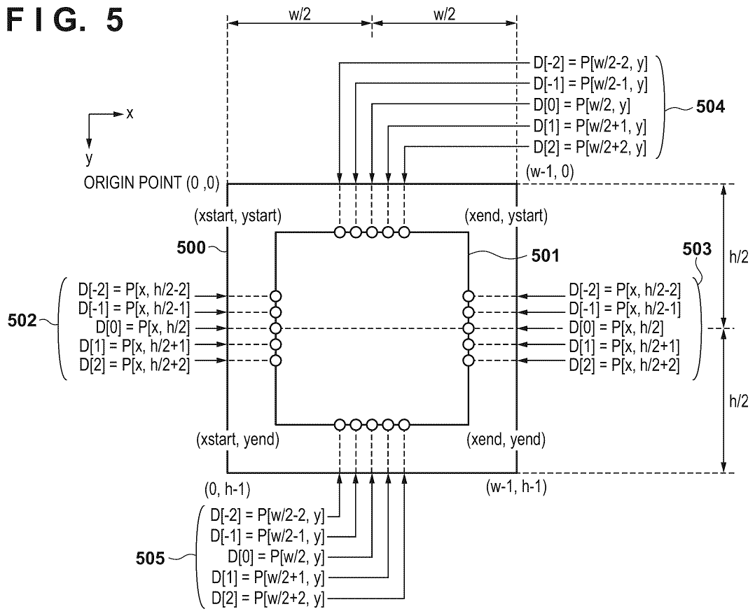

After the inspection image (image data) is acquired, a step in which the region detection device 103 detects a display region from the inspection image is performed. Assume here that the inspection image is rectangle, as shown in FIG. 5, and is formed by pixels arranged in a matrix in the x direction and the y direction. A description will be provided using the top, bottom, left, and right of an inspection image 500 shown in FIG. 5.

First, in step S202, the region detection device 103 reads out, from the image memory 102, image data for scanning a pixel value from a pixel arranged at the left end of the inspection image 500, and detects a coordinate position xstart of the left side forming the outer edge of a display region 501. Next, in step S203, the region detection device 103 reads out, from the image memory 102, image data for scanning a pixel value from a pixel arranged at the right end of the inspection image 500, and detects a coordinate position xend of the right side forming the outer edge of the display region 501. Next, in step S204, the region detection device 103 reads out, from the image memory 102, image data for scanning a pixel value from a pixel arranged at the upper end of the inspection image 500, and detects a coordinate position ystart of the upper side forming the outer edge of the display region 501. Furthermore, in step S205, the region detection device 103 reads out, from the image memory 102, image data for scanning a pixel value from a pixel arranged at the lower end of the image, and detects a coordinate position yend of the lower side forming the outer edge of the display region 501.

After the coordinate positions xstart, ystart, xend, and yend are detected, the detected coordinate positions xstart, ystart, xend, and yend of the respective sides of the display region 501 are output from the region detection device 103 to the defect inspection device 105 in step S206. When the region detection device 103 detects the coordinate positions of the sides forming the outer edge of the display region 501, the display region 501 is specified from the inspection image 500. In step S207, the defect inspection device 105 performs an operation for detecting a defect of the display region 501 specified by the region detection device 103.

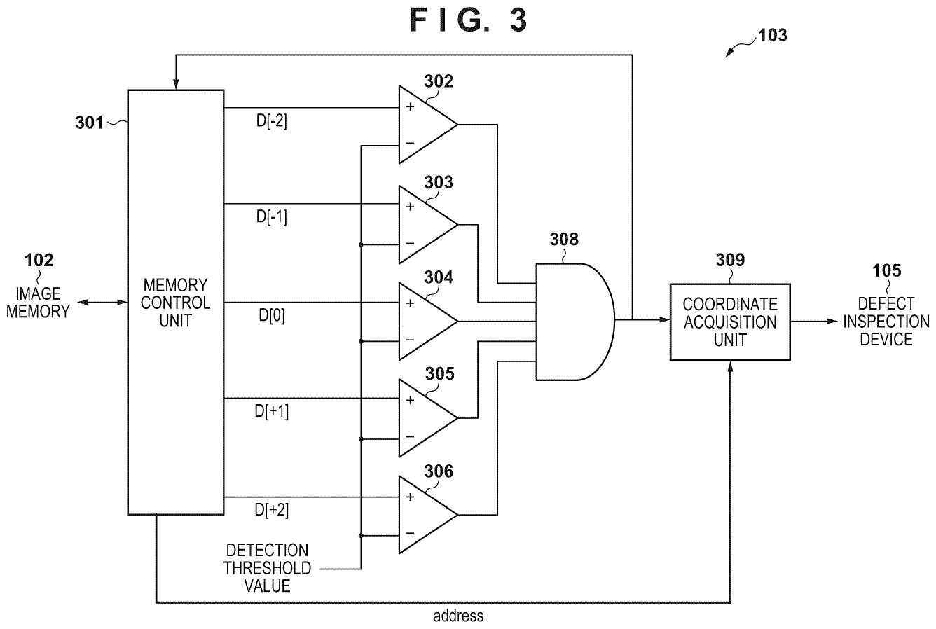

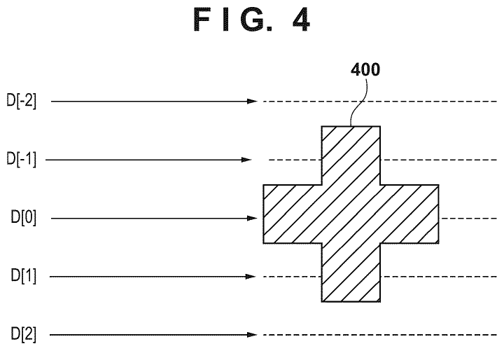

FIG. 3 is a circuit diagram showing an example of the configuration of the region detection device 103. The region detection device 103 scans plural lines set to intersect a side forming the outer edge of the display region 501, and detects the coordinate position of the side based on the pixel value of a pixel of each of the plural lines. For example, as shown in FIG. 4, data of an abnormal signal level such as a light spot may be recorded in the inspection image 500 due to a defect of the sensor panel of the image acquisition device 101 or the like. FIG. 4 shows a cross-shaped defect 400 with a width of three pixels. To prevent the light spot indicated by the defect 400 from being erroneously detected as a side forming the outer edge of the display region 501, the region detection device 103 scans, for example, lines for five pixels larger than the defect 400, and detects the coordinate position of the side forming the outer edge of the display region 501. For example, the defect inspection apparatus 100 may include a storage unit that stores the size of a defect appearing in the inspection image 500 in accordance with the characteristic of the image acquisition device 101. Then, in a direction along the side forming the outer edge of the display region 501, a range within which plural lines to be scanned by the region detection device 103 are arranged may be set to be larger than the size of the defect 400 stored in the storage unit. For example, the image memory 102 may store the size of the defect.

The region detection device 103 can include a memory control unit 301, comparators 302 to 306 each configured to compare the image data of each line with a threshold, an AND circuit 308, and a coordinate acquisition unit 309. The image data of the inspection image 500 is input from the image memory 102 to the region detection device 103 via the memory control unit 301. A threshold for detecting the display region 501 is input to each of the comparators 302 to 306. The coordinate acquisition unit 309 outputs the obtained coordinate positions xstart, ystart, xend, and yend of the respective sides forming the outer edge of the display region 501 to the defect inspection device 105.

Next, the operation of the region detection device 103 will be described with reference to FIG. 5. FIG. 5 shows the inspection image 500 and the display region 501. In addition, plural lines 502 are five lines to be scanned to detect the coordinate position xstart of the left side forming the outer edge of the display region 501. Similarly, plural lines 503, plural lines 504, or plural lines 505 are five lines to be scanned to detect the coordinate position xend of the right side, the coordinate position ystart of the upper side, or the coordinate position yend of the lower side forming the outer edge of the display region 501. The width and height of the inspection image 500 are represented by w (w pixels) and h (h pixels), respectively.

In this embodiment, the display region 501 is rectangle, and the region detection device 103 scans the plural lines 502 to 505 set for the four sides forming the outer edge of the display region 501. However, the present disclosure is not limited to this, and plural lines to be scanned are set with respect to each side forming the outer edge of the display region 501 in accordance with the shape of the display region 501. In addition, the region detection device 103 scans the plural lines 502 to 505 from the outside of the display region 501 to the display region 501 in the inspection image 500. More specifically, the region detection device 103 scans the plural lines 502 to 505 from the pixel arranged in the edge portion of the inspection image 500 to the display region 501. However, the present disclosure is not limited to this, and the region detection device 103 may perform scanning from the central portion (or center) of the inspection image 500, where the display region 501 is assumed to be located, to the edge portion.

In defect inspection, the display region 501 is normally captured to be located in the central portion of the angle of view of the inspection image 500. It is also considered that light emission is stable around the central portion of the display region 501 in the vertical direction and the horizontal direction. Therefore, to detect the display region 501, it is considered to be suitable to scan a portion around the central portion of the inspection image 500 in the vertical direction and the horizontal direction. Thus, the central pixel of the inspection image 500 in the direction along the side of the display region 501 to be detected may be arranged within a range in which the plural lines 502, 503, 504, or 505 are arranged in the direction along the side of the display region 501 to be detected. When w and h are odd numbers, the central pixel is a pixel represented by a position of (w/2+0.5, h/2+0.5). When w and h are even numbers, the central pixel may be a pixel represented by a position of (w/2, h/2), a pixel represented by a position of (w/2+1, h/2+1), or both of them. The central line (indicated by D[0] in FIG. 5) of the plural lines 502, 503, 504, or 505 may be formed by the central pixel. Similar to the central pixel, when the number of plural lines 502, 503, 504, or 505 is an odd number, as shown in FIG. 5, one line is determined as the central line of the plural lines 502, 503, 504, or 505. Alternatively, if the number of plural lines 502, 503, 504, or 505 is an even number, two central lines or one of them may be determined as the central line of the plural lines 502, 503, 504, or 505. In FIG. 5, assume that the centers in the x direction and the y direction are represented by y=w/2 and x=h/2, respectively.

The threshold to be compared with the pixel value of the image data of each line by each of the comparators 302 to 306 may be set in accordance with the pixel value of the pixel arranged in the central portion of the inspection image 500. For example, the defect inspection apparatus 100 can perform defect inspection of the plurality of display devices 107 of the same type. In this case, the threshold may be set in accordance with the pixel values of the pixels arranged in the central portions of the plurality of inspection images 500. The central pixel of the inspection image 500 may include, for example, 5% of the pixels between the central position of the inspection image 500 and the edge portion from the central position to the edge portion. Furthermore, the central pixel of the inspection image 500 may include, for example, 10% of the pixels between the central position of the inspection image 500 and the edge portion from the central position to the edge portion. As the threshold, a value of a level lower than the luminance of the central region where the display region 501 of the inspection image 500 in the lighting state is assumed to be captured can be set. For example, the image acquisition device 101 or the region detection device 103 may set the threshold in accordance with the luminance of the central portion of the inspection image 500. Alternatively, for example, the user may extract, by visual observation, the luminance of the display region 501 displayed in the inspection image 500, and set, as the threshold, a level lower than the luminance.

Next, the detection of the coordinate position xstart of the left side forming the outer edge of the display region 501, which is shown in step S202 of FIG. 2 and performed by the region detection device 103, will be described. Scanning is performed from x=0 in the +x direction. The y-coordinate of D[0] indicating the central line of the plural lines 502 to be scanned is set to h/2.

First, image data P[x, h/2−2], P[x, h/2−1], P[x, h/2], P[x, h/2+1], and P[x, h/2+2] for five lines adjacent to each other are read out from the image memory 102 via the memory control unit 301. The image data P are input to the comparators 302 to 306 via D[−2], D[−1], D[0], D[1], and D[2], respectively. The comparators 302 to 306 compare the pixel values of the pixels included in the plural lines 502 with the threshold. The comparison results of the comparators 302 to 306 are input to the AND circuit 308. The AND circuit 308 outputs “1” when all the outputs of the comparators 302 to 306 are “1” (all the pixel values of the five lines are equal to or larger than the threshold). The coordinate acquisition unit 309 acquires, as the coordinate position xstart, the x-coordinate value when the output of the AND circuit 308 changes from “0” to “1”. That is, a position in the scanning direction at which all the pixel values of the plural lines 502 change from values smaller than the threshold to values equal to or larger than the threshold is detected as the coordinate position xstart. At this time, the memory control unit 301 is notified of the output “1” of the AND circuit 308 as an acquisition end signal of the coordinate position xstart. Upon receiving the acquisition end signal, the memory control unit 301 shifts to a step of detecting the coordinate position xend in step S203.

The detection of the coordinate position xend of the right side forming the outer edge of the display region 501, which is shown in step S203 of FIG. 2, is performed by scanning from x=w−1 in the −x direction. The remaining operations are the same as those in the method of detecting the coordinate position xstart, and the coordinate acquisition unit 309 acquires, as the coordinate position xend, the x-coordinate value when the output of the AND circuit 308 changes from “0” to “1”. At this time, the memory control unit 301 is notified of the output “1” of the AND circuit 308 as an acquisition end signal of the coordinate position xend. Upon receiving the acquisition end signal, the memory control unit 301 shifts to a step of detecting the coordinate position ystart in step S204.

Next, the detection of the coordinate position ystart of the upper side forming the outer edge of the display region 501, which is shown in step S204 of FIG. 2 and performed by the region detection device 103, will be described. Scanning is performed from y=0 in the ty direction. The x-coordinate of D[0] indicating the central line of the plural lines 504 to be scanned is set to w/2.

First, image data P[w/2−2, y], P[w/2−1, y], P[w/2, y], P[w/2+1, y], and P[w/2+2, y] for five lines adjacent to each other are read out from the image memory 102 via the memory control unit 301. The image data P are input to the comparators 302 to 306 via D[−2], D[−1], D[0], D[1], and D[2], respectively. The comparison results of the comparators 302 to 306 are input to the AND circuit 308. The AND circuit 308 outputs “1” when all the outputs of the comparators 302 to 306 are “1” (all the pixel values of the five lines are equal to or larger than the threshold). The coordinate acquisition unit 309 acquires, as the coordinate position ystart, the y-coordinate value when the output of the AND circuit 308 changes from “0” to “1”. At this time, the memory control unit 301 is notified of the output “1” of the AND circuit 308 as an acquisition end signal of the coordinate position ystart. Upon receiving the acquisition end signal, the memory control unit 301 shifts to a step of detecting the coordinate position yend in step S205.

The detection of the coordinate position yend of the lower side forming the outer edge of the display region 501, which is shown in step S205 of FIG. 2, is performed by scanning from y=h−1 in the −y direction. The remaining operations are the same as those in the method of detecting the coordinate position ystart, and the coordinate acquisition unit 309 acquires, as the coordinate position yend, the y-coordinate value when the output of the AND circuit 308 changes from “0” to “1”. At this time, the memory control unit 301 is notified of the output “1” of the AND circuit 308 as an acquisition end signal of the coordinate position yend. Upon receiving the acquisition end signal, the memory control unit 301 ends the detection of the coordinate positions of the display region 501.

After that, as shown in step S206 of FIG. 2, the coordinate positions xstart, xend, ystart, and yend of the display region 501 detected by the region detection device 103 are sent from the region detection device 103 to the defect inspection device 105. For example, the region detection device 103 may supply, to the defect inspection device 105, the values of the coordinate positions xstart, xend, ystart, and yend corresponding to the respective sides forming the outer edge of the display region 501. Alternatively, for example, the region detection device 103 may supply the coordinates (xstart, ystart), (xend, ystart), (xstart, yend), and (xend, yend) of the four corners of the display region 501 to the defect inspection device 105.

As described above, the region detection device 103 detects the coordinate positions of the respective sides forming the outer edge of the display region 501 by scanning the plural lines 502 to 505. Thus, even in a case where the inspection image 500 obtained by the image acquisition device 101 includes the defect 400 caused by the sensor panel of the image acquisition device 101 or the like, it is possible to suppress the influence of the defect 400 and extract the inspection region (display region 501) of the display device 107. That is, detection accuracy of the display region 501 is improved.

Furthermore, when detecting the coordinate position of each side forming the outer edge of the display region 501, it is considered to scan the overall inspection image 500. However, along with an increase in size and an increase in number of pixels of the sensor panel of the image acquisition device 101 for acquiring the inspection image 500, the number of pixels to be scanned increases and the calculation amount increases. On the other hand, the region detection device 103 according to this embodiment detects one side by scanning a small number of lines, for example, five lines. Therefore, even in a case where the size and the number of pixels of the sensor panel of the image acquisition device 101 increase, it is possible to suppress a detection error of the defect 400 and detect the display region 501 of the display device 107 while suppressing an increase in calculation amount.

The above embodiment has explained an example in which scanning is performed from the edge portion of the inspection image 500 to the central portion. However, scanning may be performed from the central portion (or center) of the inspection image 500 to the edge portion. In this case, each coordinate position is acquired when the output of the AND circuit changes from “1” to “0”.

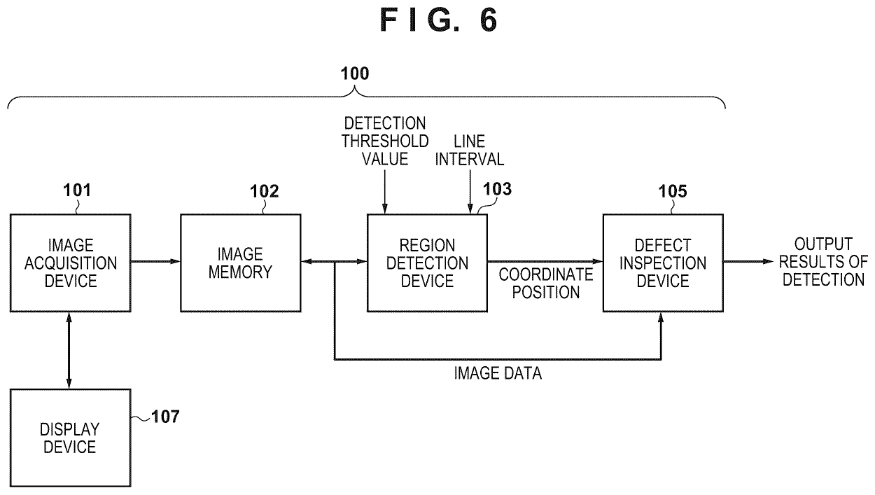

A modification of the above-described defect inspection apparatus 100 and region detection device 103 will be described next with reference to FIGS. 6 to 9. FIG. 6 is a block diagram showing a modification of the above-described defect inspection apparatus 100. In the above-described embodiment, in the region detection device 103, lines adjacent to each other of the plural lines 502, 503, 504, or 505 are formed by pixels arranged to be adjacent to each other in a direction along a detection target side. However, the present disclosure is not limited to this, and a pixel not forming the plural lines 502, 503, 504, or 505 may be arranged between the lines adjacent to each other of the plural lines 502, 503, 504, or 505. The configuration shown in FIG. 6 corresponds to a case where a plurality of defects caused by the sensor panel of the image acquisition device 101 or the like are adjacent to each other, and scans a wider range in the direction along the detection target edge than in the above-described embodiment.

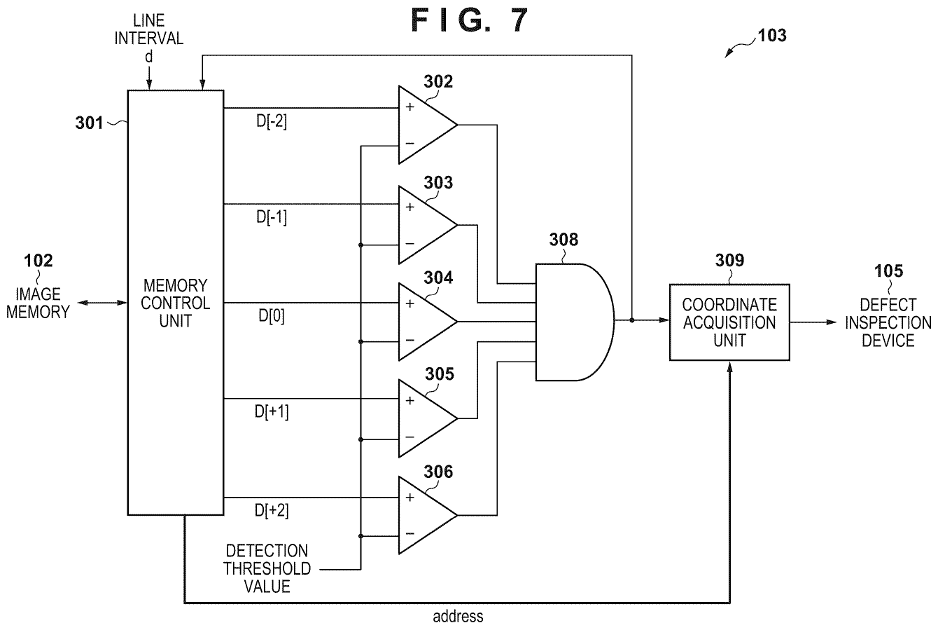

As shown in FIG. 6, the defect inspection apparatus 100 can have the same configuration as that shown in FIG. 1 except that a signal for designating a line interval between the lines adjacent to each other is input to the region detection device 103. FIG. 7 is a circuit diagram showing an example of the configuration of the region detection device 103 according to this embodiment. As shown in FIG. 7, the configuration is the same as that shown in FIG. 3 except that a line interval d is input to the memory control unit 301. For example, if “1” is input as the line interval d, the lines adjacent to each other of the plural lines 502, 503, 504, or 505 are formed by the pixels arranged to be adjacent to each other in the direction along the detection target side. That is, the region detection device 103 performs the same operation as in the above-described embodiment. Therefore, points different from the above-described configuration will mainly be described, and a description of components that may be the same as in the above-described configuration will be omitted appropriately. For example, the processing procedure of the defect inspection apparatus 100 can be the same as that shown in FIG. 2.

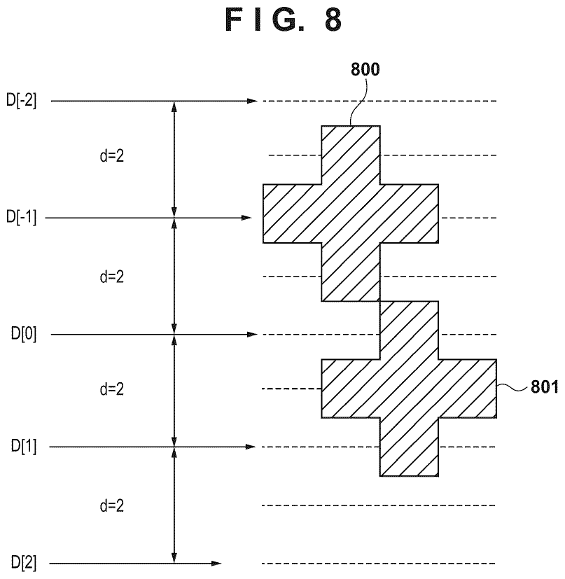

The region detection device 103 shown in FIG. 7 is effective in a case where a plurality of defects 800 and 801 appear close to each other in the inspection image 500, as shown in FIG. 8. For example, as shown in FIG. 8, the region detection device 103 scans the lines for five pixels at the line interval d (in the case shown in FIG. 8, d=2) larger than the line interval shown in FIG. 4 so as not to erroneously detect the defects 800 and 801 for six pixels. As a result, a width scanned by the region detection device 103 in the direction along the detection target side corresponds to 10 pixels, and a detection error of the defects 800 and 801 is suppressed, thereby improving detection accuracy of the coordinate positions of the sides forming the outer edge of the display region 501.

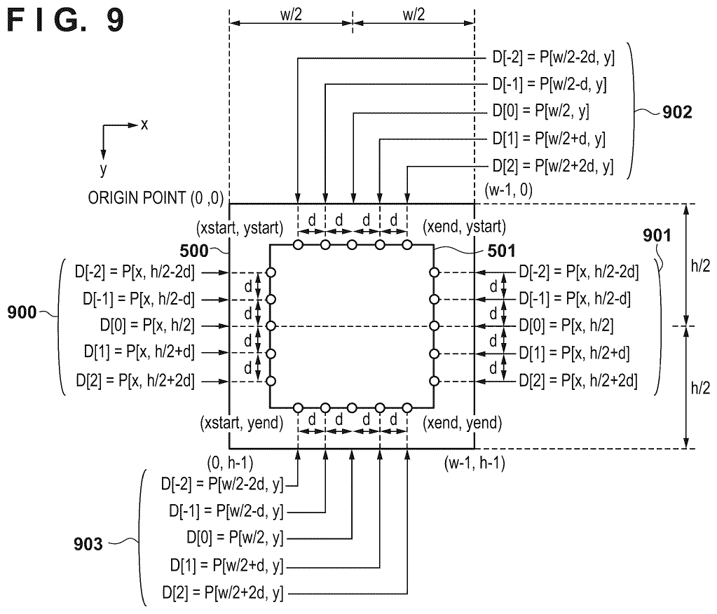

Next, the operation of the region detection device 103 according to this embodiment will be described with reference to FIG. 9. A description of components that may be the same as those shown in FIG. 5 will be omitted appropriately. Similar to the operation according to the above-described embodiment, the memory control unit 301 is provided with information (w, h) of the width and height of the inspection image 500. In this example, as illustrated in the flowchart shown in FIG. 2, the coordinates of the respective sides forming the outer edge of the display region 501 are detected in the order of the coordinate positions xstart, xend, ystart, and yend.

Plural lines 900 shown in FIG. 9 are five lines to be scanned to detect the coordinate position xstart of the left side forming the outer edge of the display region 501. Similarly, plural lines 901, plural lines 902, or plural lines 903 are five lines to be scanned to detect the coordinate position xend of the right side, the coordinate position ystart of the upper side, or the coordinate position yend of the lower side forming the outer edge of the display region 501. Similar to the above-described embodiment, the centers in the x direction and the y direction are represented by y=w/2 and x=h/2, respectively.

First, the detection of the coordinate position xstart of the left side forming the outer edge of the display region 501, which is shown in step S202 of FIG. 2 and performed by the region detection device 103, will be described. Scanning is performed from x=0 in the +x direction. The y-coordinate of D[0] indicating the central line of the plural lines 900 to be scanned is set to h/2.

Image data P[x, h/2−2d], P[x, h/2−d], P[x, h/2], P[x, h/2+d], and P[x, h/2+2d] for five lines with the set line interval d are read out from the image memory 102 via the memory control unit 301. The line interval d may be set by the user inputting an appropriate value. Alternatively, for example, data for setting the line interval d may be sent, to the region detection device 103, from a storage unit (which may be, for example, the image memory 102) that stores the size of a defect appearing in the inspection image 500 in accordance with the characteristic of the image acquisition device 101. The image data P are input to the comparators 302 to 306 via D[−2], D[−1], D[0], D[1], and D[2], respectively. Operations after that can be the same as those described with reference to FIG. 5, and the coordinate acquisition unit 309 acquires, as the coordinate position xstart, the x-coordinate value when the output of the AND circuit 308 changes from “0” to “1”. At this time, the memory control unit 301 is notified of the output “1” of the AND circuit 308 as an acquisition end signal of the coordinate position xstart. Upon receiving the acquisition end signal, the memory control unit 301 shifts to a step of detecting the coordinate position xend in step S203.

The detection of the coordinate position xend of the right side forming the outer edge of the display region 501, which is shown in step S203 of FIG. 2, is performed by scanning from x=w−1 in the −x direction. The remaining operations are the same as those in the method of detecting the coordinate position xstart, and the coordinate acquisition unit 309 acquires, as the coordinate position xend, the x-coordinate value when the output of the AND circuit 308 changes from “0” to “1”. At this time, the memory control unit 301 is notified of the output “1” of the AND circuit 308 as an acquisition end signal of the coordinate position xend. Upon receiving the acquisition end signal, the memory control unit 301 shifts to a step of detecting the coordinate position ystart in step S204.

Next, the detection of the coordinate position ystart of the upper side forming the outer edge of the display region 501, which is shown in step S204 of FIG. 2 and performed by the region detection device 103, will be described. Scanning is performed from y=0 in the ty direction. The x-coordinate of D[0] indicating the central line of the plural lines 504 to be scanned is set to w/2. First, image data P[w/2−2d, y], P[w/2−d, y], P[w/2, y], P[w/2+d, y], and P[w/2+2d, y] for five lines with the line interval d are read out from the image memory 102 via the memory control unit 301. The image data P are input to the comparators 302 to 306 via D[−2], D[−1], D[0], D[1], and D[2], respectively. Operations after that can be the same as those described with reference to FIG. 5, and the coordinate acquisition unit 309 acquires, as the coordinate position ystart, the y-coordinate value when the output of the AND circuit 308 changes from “0” to “1”. At this time, the memory control unit 301 is notified of the output “1” of the AND circuit 308 as an acquisition end signal of the coordinate position ystart. Upon receiving the acquisition end signal, the memory control unit 301 shifts to a step of detecting the coordinate position yend in step S205.

The detection of the coordinate position yend of the lower side forming the outer edge of the display region 501, which is shown in step S205 of FIG. 2, is performed by scanning from y=h−1 in the −y direction. The remaining operations are the same as those in the method of detecting the coordinate position ystart, and the coordinate acquisition unit 309 acquires, as the coordinate position yend, the y-coordinate value when the output of the AND circuit 308 changes from “0” to “1”. At this time, the memory control unit 301 is notified of the output “1” of the AND circuit 308 as an acquisition end signal of the coordinate position yend. Upon receiving the acquisition end signal, the memory control unit 301 ends the detection of the coordinate positions of the display region 501.

After that, as shown in step S206 of FIG. 2, the coordinate positions xstart, xend, ystart, and yend of the display region 501 detected by the region detection device 103 are sent from the region detection device 103 to the defect inspection device 105. For example, the region detection device 103 may supply, to the defect inspection device 105, the values of the coordinate positions xstart, xend, ystart, and yend corresponding to the respective sides forming the outer edge of the display region 501. Alternatively, for example, the region detection device 103 may supply the coordinates (xstart, ystart), (xend, ystart), (xstart, yend), and (xend, yend) of the four corners of the display region 501 to the defect inspection device 105.

As described above, in the configuration shown in FIGS. 6 to 9, the region detection device 103 detects the coordinate positions of the respective sides forming the outer edge of the display region 501 by scanning the plural lines 502 to 505 at each predetermined line interval d. Thus, even in a case where the inspection image 500 obtained by the image acquisition device 101 includes a defect larger than the defect 400 (FIG. 4) caused by the sensor panel of the image acquisition device 101 or the like or a plurality of defects like the defects 800 and 801, it is possible to suppress the influence of the defect. That is, detection accuracy of the inspection region (display region 501) of the display device 107 is improved.

The line interval d may be 2, as described above, or may be 3 or more. The line interval d can be changed appropriately in accordance with the characteristic of the sensor panel of the image acquisition device 101. In the above-described embodiment, the central position of the lines to be scanned to detect the coordinate position xstart or xend is set to y=h/2, and the central position of the lines to be scanned to detect the coordinate position ystart or yend is set to x=w/2. However, the present disclosure is not limited to this, and the central position may be set to an arbitrary position as long as it is possible to ensure brightness of a level at which the coordinate position of the display region 501 is acquired. For example, as the central line of the plural lines 502, 503, 504, or 505 or the plural lines 900, 901, 902, or 903, an appropriate position is selected in accordance with the pixel values of the display region 501 of the display device 107.

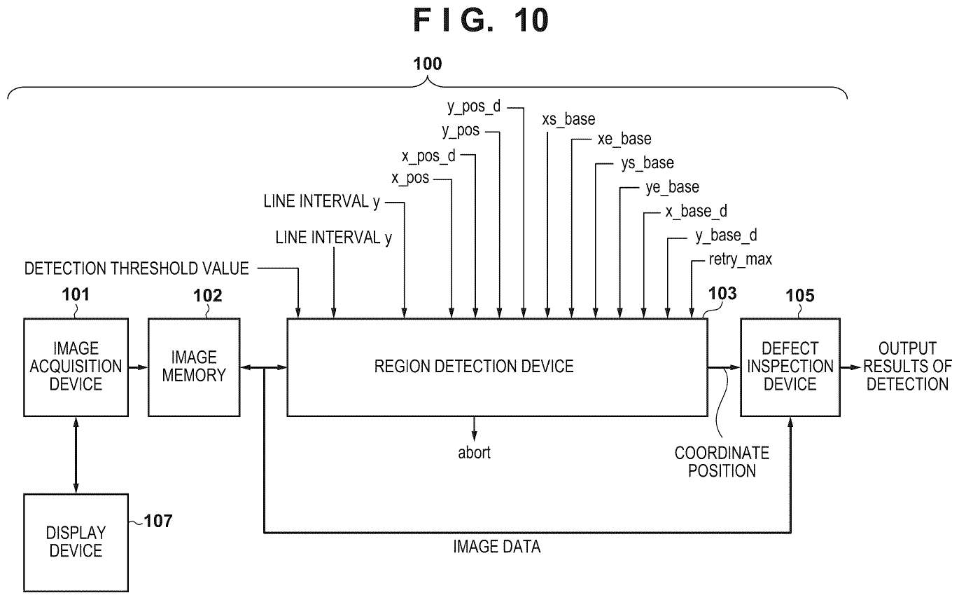

A modification of the above-described defect inspection apparatus 100 and region detection device 103 will be described next with reference to FIGS. 10 to 17. This embodiment includes error processing (abortion of inspection) in a case where it is impossible to appropriately detect the display region 501 of the display device 107 from the inspection image 500 acquired by the image acquisition device 101. More specifically, in a case where the coordinate position of each side forming the outer edge of the detected display region 501 falls outside the range of a preset effective coordinate region, the region detection device 103 processes the inspection image 500 as an error image. Furthermore, in this embodiment, the central position of the lines to be scanned to detect the coordinate position xstart or xend and the central position of the lines to be scanned to detect the coordinate position ystart or yend can be set to arbitrary positions. For example, the central positions of the lines to be scanned to detect the coordinate positions xstart, xend, ystart, and yend are set to appropriate positions in accordance with the pixel values of the display region 501. The central positions of the lines may be designated by the user with reference to the inspection image 500 or may automatically be decided by a processing circuit (not shown) arranged in the defect inspection apparatus 100 or the region detection device 103 with reference to the inspection image 500.

In addition to the threshold used by the comparators 302 to 306, the following settings are input to the region detection device 103. A line interval x sets the interval between adjacent lines of the plural lines when detecting the coordinate position ystart or yend. A line interval y sets the interval between adjacent lines of the plural lines when detecting the coordinate position xstart or xend. A setting x_pos sets the position in the x direction of the central line of the plural lines when detecting the coordinate position ystart or yend. A setting x_pos_d sets the number (the number of pixels) by which the positions of the plural lines are to be shifted in the direction along the target side in a case where the detected coordinate position falls outside the preset range when detecting the coordinate position ystart or yend, as will be described later. A setting y_pos sets the position in the y direction of the central line of the plural lines when detecting the coordinate position xstart or xend. A setting x_pos_d sets the number (the number of pixels) by which the positions of the plural lines are to be shifted in the direction along the target side in a case where the detected coordinate position falls outside the preset range when detecting the coordinate position xstart or xend. A setting xs_base sets the central coordinate of the effective coordinate region of the coordinate position xstart. A setting xe_base sets the central coordinate of the effective coordinate region of the coordinate position xend. A setting ys_base sets the central coordinate of the effective coordinate region of the coordinate position ystart. A setting ye_base sets the central coordinate of the effective coordinate region of the coordinate position yend. Settings x_base_d and y_base_d set the range of the effective coordinate region from the central coordinates set by the settings xs_base, xe_base, ys_base, and ye_base. A setting retry_max sets the maximum value of the number of times the positions of the plural lines are shifted in the direction along the target side in a case where the detected coordinate position falls outside the range of the preset effective coordinate region. In a case where the coordinate position of each side forming the outer edge of the detected display region 501 falls outside the range of the preset effective coordinate region, the region detection device 103 performs error processing. That is, in a case where it is impossible to appropriately detect the display region 501 of the display device 107 from the inspection image 500, an interruption notification abort indicating that scanning has been aborted is output.

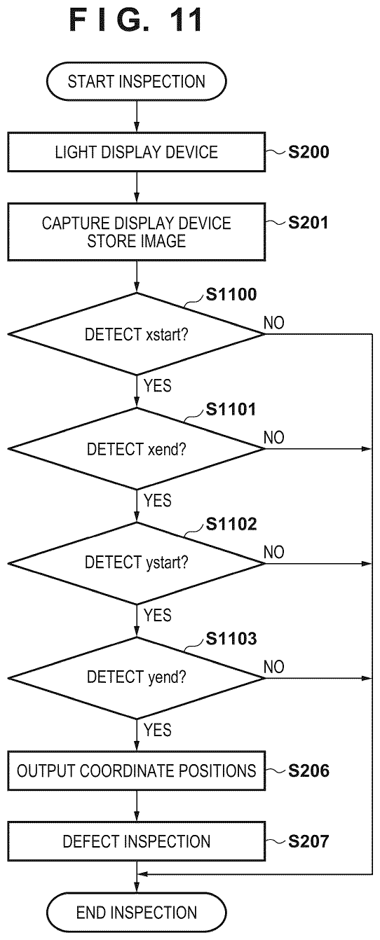

FIG. 11 shows the processing procedure of the defect inspection apparatus 100 shown in FIG. 10. Operations in steps S201 and S202 are the same as those described with reference to FIG. 2. Next, in step S1100, the region detection device 103 reads out, from the image memory 102, the image data for scanning the pixel values from the pixel arranged at the left end of the inspection image 500, and detects the coordinate position xstart of the left side forming the outer edge of the display region 501. If the coordinate position xstart is normally detected (the coordinate position xstart falls within the range of the effective coordinate region set by the settings xs_base and x_base_d), the process advances to step S1101. On the other hand, if the detected coordinate position xstart falls outside the range of the effective coordinate region preset by the settings xs_base and x_base_d, the region detection device 103 shifts the positions of the plural lines to be scanned in accordance with the setting y_pos_d. Next, by scanning the plural lines again, the coordinate position xstart is detected. If the detected coordinate position xstart falls outside the range of the preset effective coordinate region, the region detection device 103 repeats the shift of the positions of the plural lines and the scanning of the plural lines. If the region detection device 103 repeats the shift and the scanning the predetermined number of times set by the setting retry_max and the coordinate position xstart falls outside the range of the preset effective coordinate region, the region detection device 103 determines that the coordinate position xstart is not detectable, and aborts the scanning of the plural lines. Thus, the defect inspection apparatus 100 ends the inspection.

If the coordinate position xstart is normally detected, the region detection device 103 reads out, in step S1101, from the image memory 102, the image data for scanning the pixel values from the pixel arranged at the right end of the inspection image 500, and detects the coordinate position xend of the right side forming the outer edge of the display region 501. If the coordinate position xend is normally detected (the coordinate position xend falls within the range of the effective coordinate region set by the settings xe_base and x_base_d), the process advances to step S1102. On the other hand, if the detected coordinate position xend falls outside the range of the effective coordinate region preset by the settings xe_base and x_base_d, the region detection device 103 shifts the positions of the plural lines to be scanned in accordance with the setting y_pos_d. Next, the plural lines are scanned again. Similar to the detection of the coordinate position xstart, if the detected coordinate position xend falls outside the range of the preset effective coordinate region, the region detection device 103 repeats the shift of the positions of the plural lines and the scanning of the plural lines. If the region detection device 103 repeats the shift and the scanning the predetermined number of times set by the setting retry_max and the coordinate position xend falls outside the range of the preset effective coordinate region, the region detection device 103 determines that the coordinate position xend is not detectable, and aborts the scanning of the plural lines. Thus, the defect inspection apparatus 100 ends the inspection.

If the coordinate position xend is normally detected, the region detection device 103 reads out, in step S1102, from the image memory 102, the image data for scanning the pixel values from the pixel arranged at the upper end of the inspection image 500, and detects the coordinate position ystart of the upper side forming the outer edge of the display region 501. If the coordinate position ystart is normally detected (the coordinate position ystart falls within the range of the effective coordinate region set by the settings ys_base and y_base_d), the process advances to step S1103. On the other hand, if the detected coordinate position ystart falls outside the range of the effective coordinate region preset by the settings ys_base and y_base_d, the region detection device 103 shifts the positions of the plural lines to be scanned in accordance with the setting x_pos_d. Next, the plural lines are scanned again. Similar to the detection of the coordinate position xstart or xend, if the detected coordinate position ystart falls outside the range of the preset effective coordinate region, the region detection device 103 repeats the shift of the positions of the plural lines and the scanning of the plural lines. If the region detection device 103 repeats the shift and the scanning the predetermined number of times set by the setting retry_max and the coordinate position ystart falls outside the range of the preset effective coordinate region, the region detection device 103 determines that the coordinate position ystart is not detectable, and aborts the scanning of the plural lines. Thus, the defect inspection apparatus 100 ends the inspection.

If the coordinate position ystart is normally detected, the region detection device 103 reads out, in step S1103, from the image memory 102, the image data for scanning the pixel values from the pixel arranged at the lower end of the inspection image 500, and detects the coordinate position yend of the lower side forming the outer edge of the display region 501. If the coordinate position yend is normally detected (the coordinate position yend falls within the range of the effective coordinate region set by the settings ye_base and y_base_d), the process advances to step S206. On the other hand, if the detected coordinate position yend falls outside the range of the effective coordinate region preset by the settings ye_base and y_base_d, the region detection device 103 shifts the positions of the plural lines to be scanned in accordance with the setting x_pos_d. Next, the plural lines are scanned again. Similar to the detection of the coordinate position xstart, xend, or ystart, if the detected coordinate position yend falls outside the range of the preset effective coordinate region, the region detection device 103 repeats the shift of the positions of the plural lines and the scanning of the plural lines. If the region detection device 103 repeats the shift and the scanning the predetermined number of times set by the setting retry_max and the coordinate position yend falls outside the range of the preset effective coordinate region, the region detection device 103 determines that the coordinate position yend is not detectable, and aborts the scanning of the plural lines. Thus, the defect inspection apparatus 100 ends the inspection.

After the coordinate positions xstart, ystart, xend, and yend are detected, the coordinate positions xstart, ystart, xend, and yend of the respective sides of the detected display region 501 are output from the region detection device 103 to the defect inspection device 105 in step S206. When the region detection device 103 detects the coordinate positions of the sides forming the outer edge of the display region 501, the display region 501 is specified from the inspection image 500. In step S207, the defect inspection device 105 performs an operation for detecting a defect of the display region 501 specified by the region detection device 103.

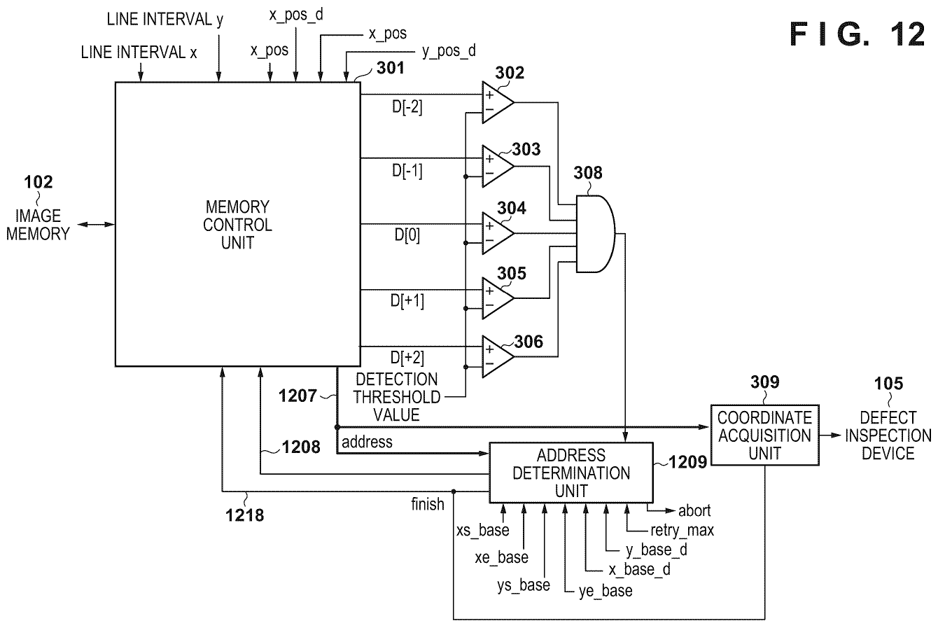

Next, the configuration of the region detection device 103 according to this embodiment will be described with reference to FIG. 12. Components different from those shown in FIGS. 3 and 7 will be described and a description of components that may be the same as those shown in FIGS. 3 and 7 will be omitted appropriately.

The line interval x and the line interval y are input to the memory control unit 301. In addition, the settings x_pos, x_pos_d, y_pos, and y_pos_d are input to the memory control unit 301.

A signal 1207 is used to propagate the address of a pixel being scanned from the memory control unit 301 to an address determination unit 1209 (to be described later) and the coordinate acquisition unit 309. A signal 1208 is used to send a rescan notification from the address determination unit 1209. A signal 1218 is used to send, from the address determination unit 1209, a notification that the coordinate positions xstart, xend, ystart, and yend have been detected.

The settings xs_base, xe_base, ys_base, ye_base, x_base_d, y_base_d, and retry_max are input to the address determination unit 1209. Furthermore, in a case where it is impossible to appropriately detect the display region 501 of the display device 107 from the inspection image 500, the address determination unit 1209 outputs the interruption notification abort indicating that scanning has been aborted.

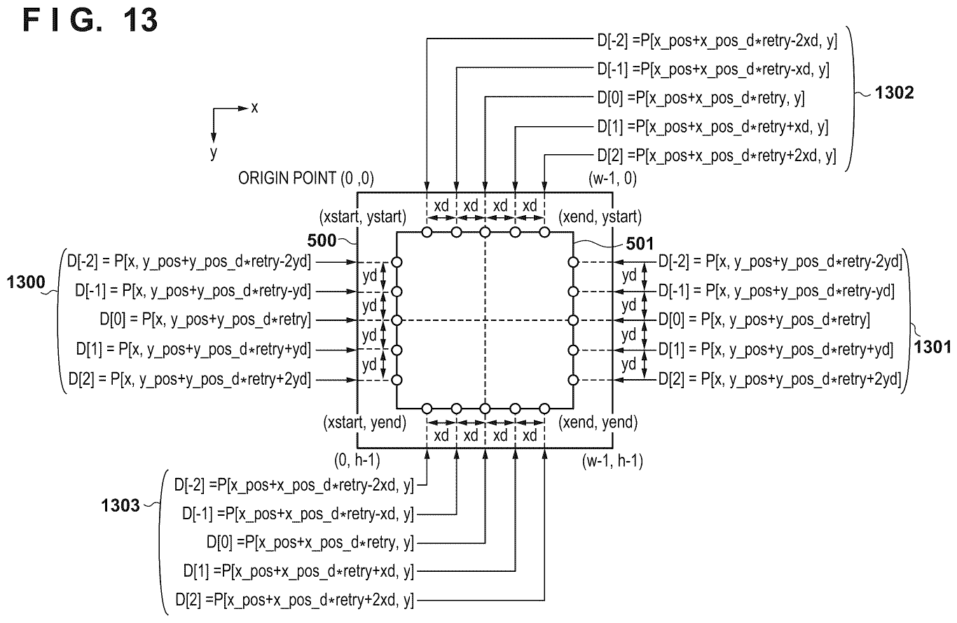

The operation of the region detection device 103 according to this embodiment will be described next with reference to FIG. 13. A description of components that may be the same as those shown in FIG. 5 will be omitted appropriately. Similar to the operation according to the above-described embodiment, the memory control unit 301 is provided with the information (w, h) of the width and height of the inspection image 500. In this example, as illustrated in the flowchart shown in FIG. 11, the coordinates of the respective sides forming the outer edge of the display region 501 are detected in the order of the coordinate positions xstart, xend, ystart, and yend. In the operation shown in FIG. 13, the line interval x is set to xd and the line interval y is set to yd.

Plural lines 1300 are five lines to be scanned to detect the coordinate position xstart of the left side forming the outer edge of the display region 501. Similarly, plural lines 1301, plural lines 1302, or plural lines 1303 are five lines to be scanned to detect the coordinate position xend of the right side, the coordinate position ystart of the upper side, or the coordinate position yend of the lower side forming the outer edge of the display region 501.

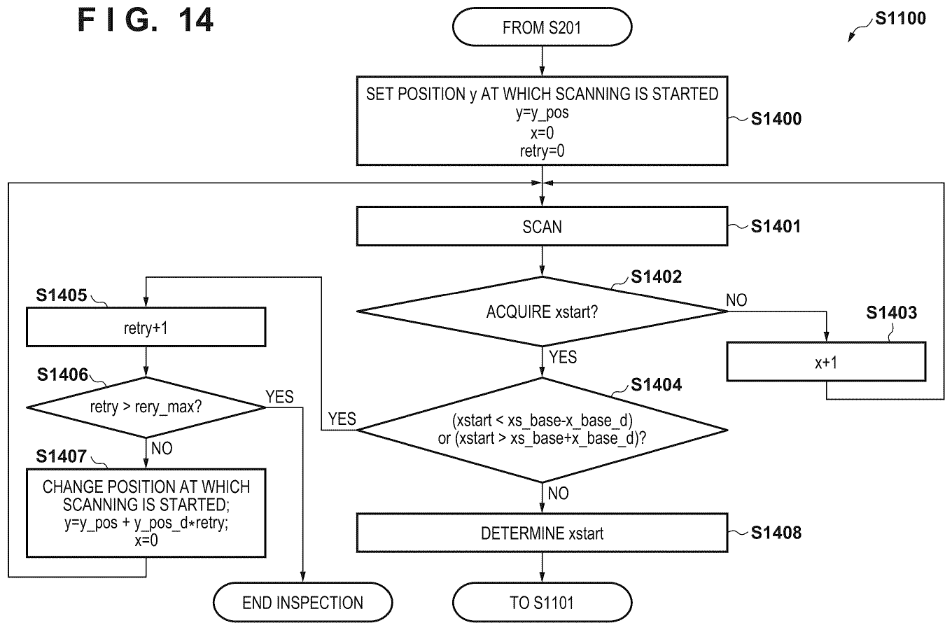

First, the detection of the coordinate position xstart of the left side forming the outer edge of the display region 501, which is shown in step S1100 of FIG. 11 and performed by the region detection device 103, will be described. FIG. 14 is a detailed flowchart illustrating the processing in step S1100.

When the process transitions from step S201 to step S1400 (S1100), a position at which scanning of the plural lines 1300 is started is set. With the setting y_pos, the y-coordinate of D[0] indicating the central line of the plural lines 1300 to be scanned is set to y_pos. In addition, an x-direction counter indicating a position in the x direction in the memory control unit 301 is set to 0, and a rescan counter retry in the address determination unit 1209 is set to 0.

Next, in each step from step S1401, scanning is performed from the left end of the inspection image 500 in the +x direction. More specifically, image data P[x, y_posty_pos_d*retry−2yd], P[x, y_posty_pos_d*retry−yd], P[x, y_pos+y_pos_d*retry], P[x, y_posty_pos_d*retry+yd], and P[x, y_posty_pos_d*retry+2yd] for five lines are read out from the image memory 102 via the memory control unit 301. The image data P are input to the comparators 302 to 306 via D[−2], D[−1], D[0], D[1], and D[2], respectively. Each of the image data P is compared with the threshold set in each of the comparators 302 to 306, and the comparison results are input to the AND circuit 308.

Next, in step S1402, it is determined whether the coordinate position xstart is acquired. More specifically, it is determined whether the AND circuit 308 outputs “1” (all the outputs of the comparators 302 to 306 are “1” (all the pixel values of the five lines are equal to or larger than the threshold)). If the output of the AND circuit 308 is not “1”, the x-direction counter is incremented by +1 in step S1403. The process returns to step S1401, and it is determined whether the AND circuit 308 outputs “1” in the next pixel in the +x direction. On the other hand, if the output of the AND circuit 308 is “1”, the process advances to step S1404.

In step S1404, the address determination unit 1209 determines whether the coordinate position xstart falls within the range of the effective coordinate region preset by the settings xs_base and x_base_d. More specifically, it is determined whether the coordinate position xstart falls within the range of xs_base±x_base_d. If the coordinate position xstart is larger than xs_base+x_base_d or smaller than xs_base-x_base_d (YES in step S1404), the coordinate position xstart falls outside the range of the effective coordinate region, and thus the process advances to step S1405.

In step S1405, the rescan counter retry is incremented by +1, the memory control unit 301 is notified of the rescan by the signal 1208, and then the process advances to step S1406. In step S1406, the address determination unit 1209 determines whether the value of the rescan counter retry is larger than the setting retry_max. If the value of the rescan counter retry is larger than the setting retry_max, it is determined that the inspection image 500 is defective and thus the coordinate position xstart cannot be detected, the address determination unit 1209 outputs the interruption notification abort, and the defect inspection apparatus 100 ends the inspection. Alternatively, if the value of the rescan counter retry is equal to or smaller than the setting retry_max, the process advances to step S1407.

In step S1407, the memory control unit 301 shifts the y-coordinate of D[0] indicating the central line of the plural lines 1300 to be scanned to a position calculated by y_pos+y_pos_d*retry. Furthermore, the x-direction counter is reset to “0” by the signal 1208. After that, the process returns to step S1402, and the above-described steps are repeated.

If it is determined in step S1404 that the coordinate position xstart falls within the range of xs_base+x_base_d (NO in step S1404), the coordinate position xstart falls within the range of the effective coordinate region, and is thus confirmed (step S1408). In other words, it is determined that the coordinate position xstart is detected. In this case, the signal 1218 is output from the address determination unit 1209 to the coordinate acquisition unit 309 to store the coordinate position xstart. The signal 1218 is also supplied to the memory control unit 301, and the memory control unit 301 shifts to a step of detecting the coordinate position xend in step S1101.

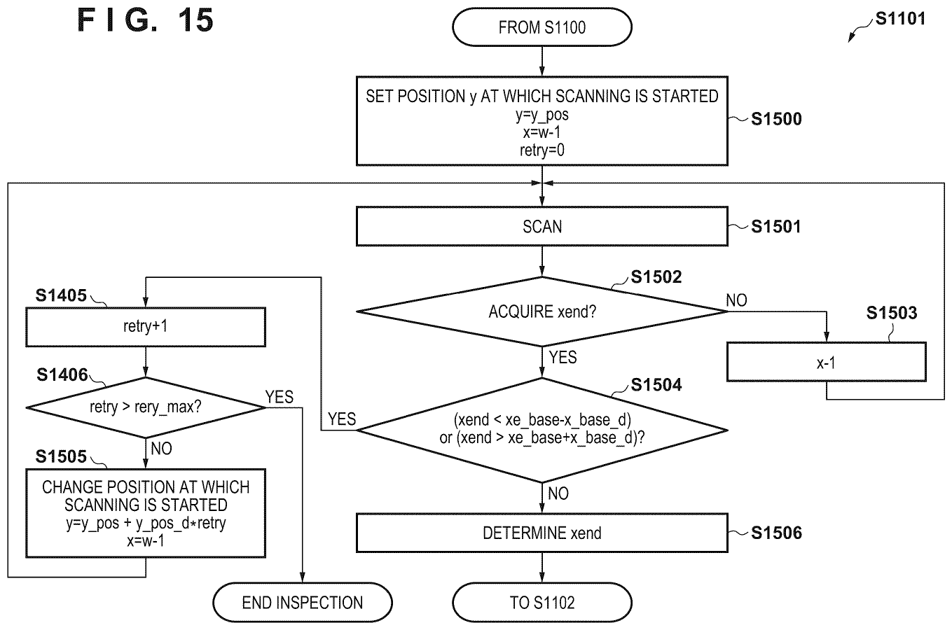

Next, the detection of the coordinate position xend of the right side forming the outer edge of the display region 501, which is shown in step S1101 of FIG. 11 and performed by the region detection device 103, will be described. FIG. 15 is a detailed flowchart illustrating the processing in step S1101. A description of the same steps as in the detection procedure of the coordinate position xstart described with reference to FIG. 14 will be omitted appropriately.

When the process transitions from step S1406 (S1100) to step S1500 (S1101), a position at which scanning of the plural lines 1301 is started is set. With the setting y_pos, the y-coordinate of D[0] indicating the central line of the plural lines 1301 to be scanned is set to y_pos. In addition, the x-direction counter indicating a position in the x direction in the memory control unit 301 is set to w−1 (the x-coordinate of the right end of the inspection image 500), and the rescan counter retry in the address determination unit 1209 is set to 0.

Next, in each step from step S1501, scanning is performed from the right end of the inspection image 500 in the −x direction. More specifically, the image data P[x, y_posty_pos_d*retry−2yd], P[x, y_posty_pos_d*retry-yd], P[x, y_pos+y_pos_d*retry], P[x, y_posty_pos_d*retry+yd], and P[x, y_posty_pos_d*retry+2yd] for five lines are read out from the image memory 102 via the memory control unit 301. The image data P are input to the comparators 302 to 306 via D[−2], D[−1], D[0], D[1], and D[2], respectively. Each of the image data P is compared with the threshold set in each of the comparators 302 to 306, and the comparison results are input to the AND circuit 308.

Next, in step S1502, it is determined whether the coordinate position xend is acquired. More specifically, it is determined whether the AND circuit 308 outputs “1” (all the outputs of the comparators 302 to 306 are “1” (all the pixel values of the five lines are equal to or larger than the threshold)). If the output of the AND circuit 308 is not “1”, the x-direction counter is decremented by −1 in step S1503. The process returns to step S1501, and it is determined whether the AND circuit 308 outputs “1” in the next pixel in the −x direction. On the other hand, if the output of the AND circuit 308 is “1”, the process advances to step S1504.

In step S1504, the address determination unit 1209 determines whether the coordinate position xend falls within the range of the effective coordinate region preset by the settings xe_base and x_base_d. More specifically, it is determined whether the coordinate position xend falls within the range of xe_base±x_base_d. If the coordinate position xend is larger than xe_base+x_base_d or smaller than xe_base-x_base_d (YES in step S1504), the coordinate position xend falls outside the range of the effective coordinate region, and thus the process advances to steps S1405 and S1406.

Steps S1405 and S1406 are the same as those in the above-described detection procedure of the coordinate position xstart. If it is determined in step S1406 that the value of the rescan counter retry is larger than the setting retry_max, it is determined that the inspection image 500 is defective and thus the coordinate position xend cannot be detected, the address determination unit 1209 outputs the interruption notification abort, and the defect inspection apparatus 100 ends the inspection. Alternatively, if the value of the rescan counter retry is equal to or smaller than the setting retry_max, the process advances to step S1505.

In step S1505, the memory control unit 301 shifts the y-coordinate of D[0] indicating the central line of the plural lines 1301 to be scanned to a position calculated by y_pos+y_pos_d*retry. Furthermore, the x-direction counter is reset to “w−1” by the signal 1208. After that, the process returns to step S1501, and the above-described steps are repeated.

If it is determined in step S1504 that the coordinate position xend falls within the range of xe_base±x_base_d (NO in step S1504), the coordinate position xend falls within the range of the effective coordinate region, and is thus confirmed (step S1506). In other words, it is determined that the coordinate position xend is detected. In this case, the signal 1218 is output from the address determination unit 1209 to the coordinate acquisition unit 309 to store the coordinate position xend. The signal 1218 is also supplied to the memory control unit 301, and the memory control unit 301 shifts to a step of detecting the coordinate position ystart in step S1102.

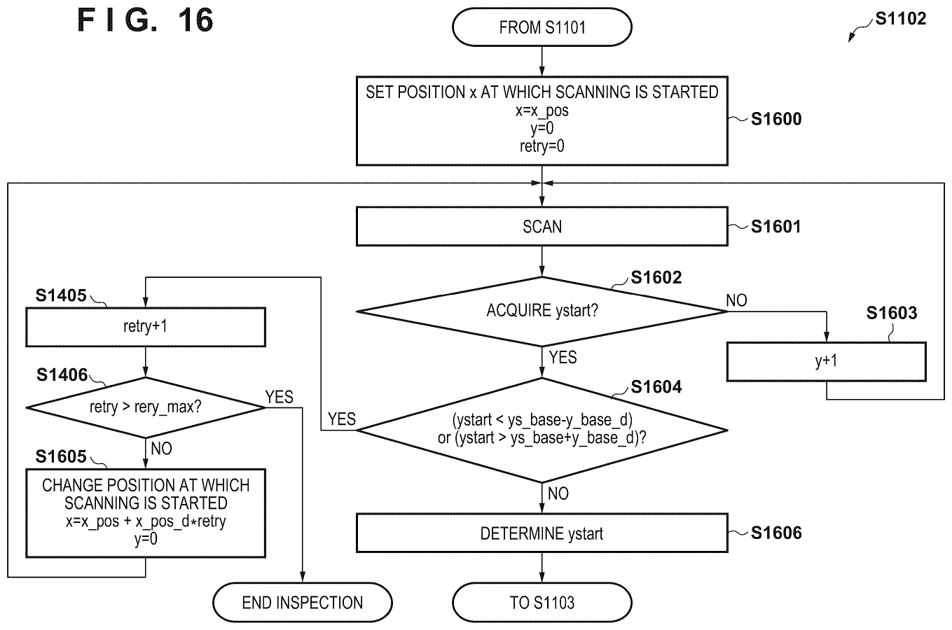

Next, the detection of the coordinate position ystart of the upper side forming the outer edge of the display region 501, which is shown in step S1102 of FIG. 11 and performed by the region detection device 103, will be described. FIG. 16 is a detailed flowchart illustrating the processing in step S1102. A description of the same steps as in the detection procedures of the coordinate positions xstart and xend described with reference to FIGS. 14 and 15 will be omitted appropriately.

When the process transitions from step S1506 (S1101) to step S1600 (S1102), a position at which scanning of the plural lines 1302 is started is set. With the setting x_pos, the x-coordinate of D[0] indicating the central line of the plural lines 1302 to be scanned is set to x_pos. In addition, a y-direction counter indicating a position in the y direction in the memory control unit 301 is set to 0, and the rescan counter retry in the address determination unit 1209 is set to 0.

Next, in each step from step S1601, scanning is performed from the upper end of the inspection image 500 in the +y direction. More specifically, image data P[x_pos+x_pos_d*retry−2xd, y], P[x_pos+x_pos_d*retry−xd, y], P[x_pos+x_pos_d*retry, y], P[x_pos+x_pos_d*retry+xd, y], and P[x_pos+x_pos_d*retry+2xd, y] for five lines are read out from the image memory 102 via the memory control unit 301. The image data P are input to the comparators 302 to 306 via D[−2], D[−1], D[0], D[1], and D[2], respectively. Each of the image data P is compared with the threshold set in each of the comparators 302 to 306, and the comparison results are input to the AND circuit 308.

Next, in step S1602, it is determined whether the coordinate position ystart is acquired. More specifically, it is determined whether the AND circuit 308 outputs “1” (all the outputs of the comparators 302 to 306 are “1” (all the pixel values of the five lines are equal to or larger than the threshold)). If the output of the AND circuit 308 is not “1”, the y-direction counter is incremented by +1 in step S1603. The process returns to step S1601, and it is determined whether the AND circuit 308 outputs “1” in the next pixel in the +y direction. On the other hand, if the output of the AND circuit 308 is “1”, the process advances to step S1604.

In step S1604, the address determination unit 1209 determines whether the coordinate position ystart falls within the range of the effective coordinate region preset by the settings ys_base and y_base_d. More specifically, it is determined whether the coordinate position ystart falls within the range of ys_base±y_base_d. If the coordinate position ystart is larger than ys_base+y_base_d or smaller than ys_base-y_base_d (YES in step S1604), the coordinate position ystart falls outside the range of the effective coordinate region, and thus the process advances to steps S1405 and S1406.

If it is determined in step S1406 that the value of the rescan counter retry is larger than the setting retry_max, it is determined that the inspection image 500 is defective and thus the coordinate position ystart cannot be detected, the address determination unit 1209 outputs the interruption notification abort, and the defect inspection apparatus 100 ends the inspection. Alternatively, if the value of the rescan counter retry is equal to or smaller than the setting retry_max, the process advances to step S1605.

In step S1605, the memory control unit 301 shifts the x-coordinate of D[0] indicating the central line of the plural lines 1302 to be scanned to a position calculated by x_pos+x_pos_d*retry. Furthermore, the y-direction counter is reset to 0 by the signal 1208. After that, the process returns to step S1601, and the above-described steps are repeated.

If it is determined in step S1604 that the coordinate position ystart falls within the range of ys_base±y_base_d (NO in step S1604), the coordinate position ystart falls within the range of the effective coordinate region, and is thus confirmed (step S1606). In other words, it is determined that the coordinate position ystart is detected. In this case, the signal 1218 is output from the address determination unit 1209 to the coordinate acquisition unit 309 to store the coordinate position ystart. The signal 1218 is also supplied to the memory control unit 301, and the memory control unit 301 shifts to a step of detecting the coordinate position yend in step S1103.

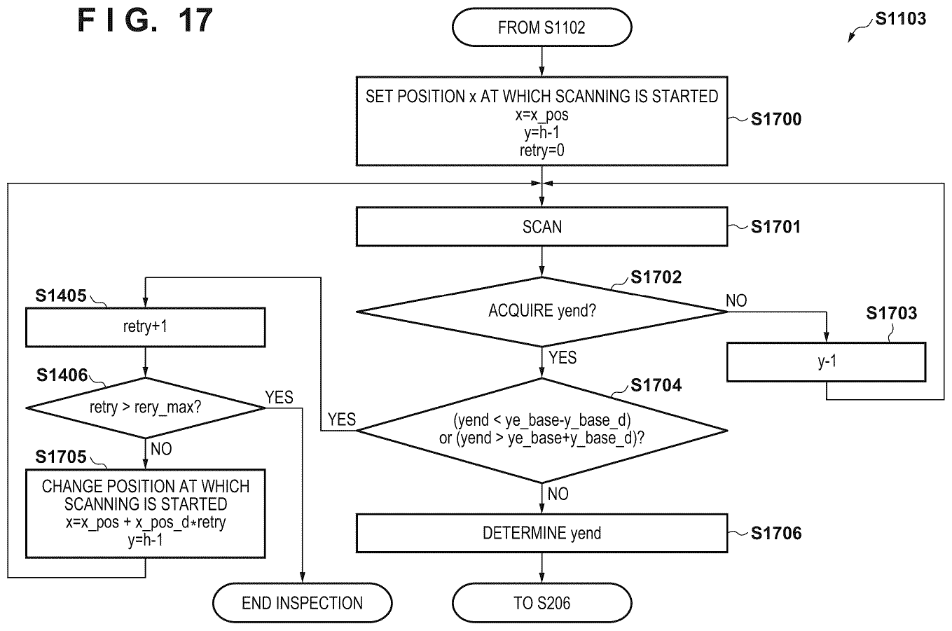

Next, the detection of the coordinate position yend of the lower side forming the outer edge of the display region 501, which is shown in step S1103 of FIG. 11 and performed by the region detection device 103, will be described. FIG. 17 is a detailed flowchart illustrating the processing in step S1103. A description of the same steps as in the detection procedures of the coordinate positions xstart, xend, and ystart described with reference to FIGS. 14 to 16 will be omitted appropriately.

When the process transitions from step S1606 (S1102) to step S1700 (S1103), a position at which scanning of the plural lines 1303 is started is set. With the setting x_pos, the x-coordinate of D[0] indicating the central line of the plural lines 1303 to be scanned is set to x_pos. In addition, the y-direction counter indicating a position in the y direction in the memory control unit 301 is set to h−1 (the y-coordinate of the lower end of the inspection image 500), and the rescan counter retry in the address determination unit 1209 is set to 0.

Next, in each step from step S1701, scanning is performed from the lower end of the inspection image 500 in the −y direction. More specifically, the image data P[x_pos+x_pos_d*retry−2xd, y], P[x_pos+x_pos_d*retry-xd, y], P[x_pos+x_pos_d*retry, y], P[x_pos+x_pos_d*retry+xd, y], and P[x_pos+x_pos_d*retry+2xd, y] for five lines are read out from the image memory 102 via the memory control unit 301. The image data P are input to the comparators 302 to 306 via D[−2], D[−1], D[0], D[1], and D[2], respectively. Each of the image data P is compared with the threshold set in each of the comparators 302 to 306, and the comparison results are input to the AND circuit 308.

Next, in step S1702, it is determined whether the coordinate position yend is acquired. More specifically, it is determined whether the AND circuit 308 outputs “1” (all the outputs of the comparators 302 to 306 are “1” (all the pixel values of the five lines are equal to or larger than the threshold)). If the output of the AND circuit 308 is not “1”, the y-direction counter is decremented by −1 in step S1703. The process returns to step S1701, and it is determined whether the AND circuit 308 outputs “1” in the next pixel in the −y direction. On the other hand, if the output of the AND circuit 308 is “1”, the process advances to step S1704.

In step S1704, the address determination unit 1209 determines whether the coordinate position yend falls within the range of the effective coordinate region preset by the settings ye_base and y_base_d. More specifically, it is determined whether the coordinate position yend falls within the range of ye_base±y_base_d. If the coordinate position yend is larger than ye_base+y_base_d or smaller than ye_base−y_base_d (YES in step S1704), the coordinate position yend falls outside the range of the effective coordinate region, and thus the process advances to steps S1405 and S1406.

Steps S1405 and S1406 are the same as those in the above-described detection procedures of the coordinate positions xstart, xend, and ystart. If it is determined in step S1406 that the value of the rescan counter retry is larger than the setting retry_max, it is determined that the inspection image 500 is defective and thus the coordinate position yend cannot be detected, the address determination unit 1209 outputs the interruption notification abort, and the defect inspection apparatus 100 ends the inspection. Alternatively, if the value of the rescan counter retry is equal to or smaller than the setting retry_max, the process advances to step S1705.

In step S1705, the memory control unit 301 shifts the x-coordinate of D[0] indicating the central line of the plural lines 1303 to be scanned to a position calculated by x_pos+x_pos_d*retry. Furthermore, the y-direction counter is reset to “h−1” by the signal 1208. After that, the process returns to step S1701, and the above-described steps are repeated.

If it is determined in step S1704 that the coordinate position yend falls within the range of ye_base+y_base_d (NO in step S1704), the coordinate position yend falls within the range of the effective coordinate region, and is thus confirmed (step S1706). In other words, it is determined that the coordinate position yend is detected. In this case, the signal 1218 is output from the address determination unit 1209 to the coordinate acquisition unit 309 to store the coordinate position yend. The signal 1218 is also supplied to the memory control unit 301, thereby ending the steps of detecting the sides forming the outer edge of the display region 501.

After the coordinate positions xstart, ystart, xend, and yend are detected, the detected coordinate positions xstart, ystart, xend, and yend of the respective sides of the display region 501 are output from the region detection device 103 to the defect inspection device 105 in step S206. For example, the region detection device 103 may supply, to the defect inspection device 105, the values of the coordinate positions xstart, xend, ystart, and yend corresponding to the respective sides forming the outer edge of the display region 501. Alternatively, for example, the region detection device 103 may supply the coordinates (xstart, ystart), (xend, ystart), (xstart, yend), and (xend, yend) of the four corners of the display region 501 to the defect inspection device 105. Next, in step S207, the defect inspection device 105 performs an operation for detecting a defect of the display region 501 specified by the region detection device 103.

As described above, when the region detection device 103 detects the coordinate position of each side forming the outer edge of the display region 501, it is determined whether the coordinate position is an appropriate position. If the coordinate position is not an appropriate position, the position is changed to perform scanning again. Thus, it is possible to detect the display region 501 of the display device 107 more reliably than in the above-described embodiment. In addition, it is possible to detect the defective inspection image 500 before inspection by the defect inspection device 105. In general, since it takes time to perform inspection by the defect inspection device 105, fail-stop to end inspection is enabled before inspection by the defect inspection device 105. This can shorten the inspection time of the whole inspection target lot such as the plurality of display devices 107.

In this embodiment, the setting x_pos_d or y_pos_d for shifting the scanning position may be a positive value or a negative value. If the setting x_pos_d or y_pos_d is a positive value, the lines to be scanned to detect the side forming the outer edge of the display region 501 are shifted in the positive direction in a case where the coordinate position is not an appropriate position. Alternatively, if the setting x_pos_d or y_pos_d is a negative value, the lines to be scanned to detect the side forming the outer edge of the display region 501 are shifted in the negative direction in a case where the coordinate position is not an appropriate position.

In the above-described embodiment, the number of lines to be scanned is set to five. However, the present disclosure is not limited to this, and the number of lines may be two to four or six or more in accordance with the size and density of the defect 400 or the defects 800 and 801 caused by the sensor panel of the image acquisition device 101. For example, the user may change the number of lines to be scanned in accordance with the inspection target lot.

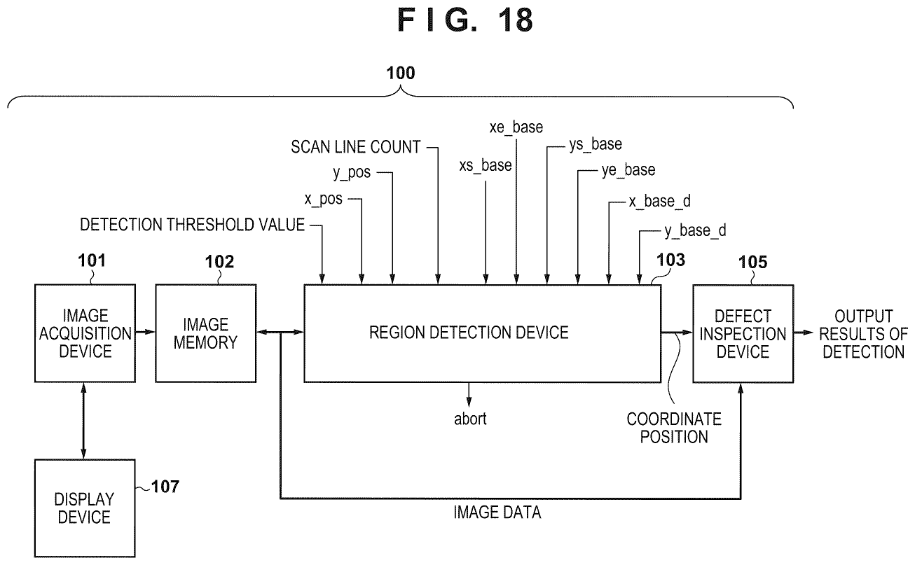

A modification of the above-described defect inspection apparatus 100 and region detection device 103 will be described next with reference to FIGS. 18 to 24. In this embodiment as well, similar to the region detection device 103 described with reference to FIGS. 10 to 17, error processing (abortion of inspection) is performed in a case where it is impossible to appropriately detect the display region 501 of the display device 107 from the inspection image 500 acquired by the image acquisition device 101. On the other hand, unlike the region detection device 103 described with reference to FIGS. 10 to 17, in a case where the coordinate position of the side forming the outer edge of the detected display region 501 falls outside the range of the preset effective coordinate region, the number of lines used to detect the coordinate position of the side is increased. By increasing the number of lines and performing scanning of the plural lines again, detection accuracy of the display region 501 of the display device 107 is improved.

As compared to the region detection device 103 shown in FIG. 10, the line interval x, the line interval y, and the settings x_pos_d, y_pos_d, and retry_max are not input to the region detection device 103 shown in FIG. 18 and a scan line count is input instead. That is, the threshold used by each of the comparators 302 to 306, the settings x_pos, y_pos, xs_base, xe_base, ys_base, ye_base, x_base_d, and y_base_d, and the scan line count are input to the region detection device 103 shown in FIG. 18. In this embodiment, the processing procedure of the region detection device 103 can be the same as that shown in FIG. 11. On the other hand, in this embodiment, if the detected coordinate position falls outside the preset range, the region detection device 103 repeats the increase of the number of lines of the plural lines used to detect the display region 501 and the scanning of the plural lines. At this time, if the coordinate position falls outside the preset range until the predetermined number of lines is reached, the region detection device 103 aborts the scanning of the plural lines, and outputs the interruption notification abort indicating that the scanning has been aborted. The predetermined number of lines is the maximum number of lines which the memory control unit 301 can read out from the image memory 102.

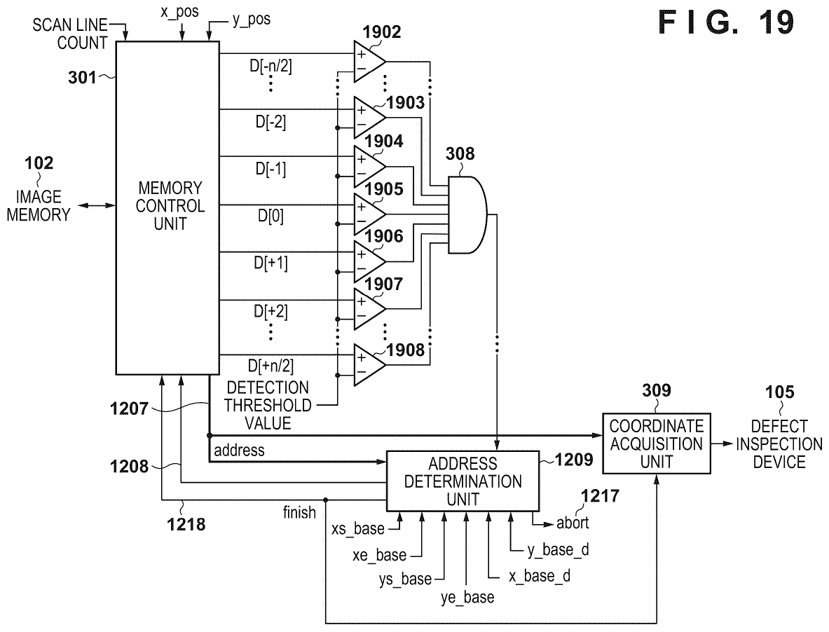

FIG. 19 is a circuit diagram showing an example of the configuration of the region detection device 103 according to this embodiment. Components different from those shown in FIG. 12 will be described and a description of components that may be the same as those shown in FIG. 12 will be omitted appropriately.

The scan line count and the settings x_pos and y_pos are input to the memory control unit 301. In this example, the memory control unit 301 can read out image data of up to (n+1) lines (n is an even number) from the image memory 102, and is connected to comparators 1902 to 1908 each configured to compare each of the readout image data of the (n+1) lines with a threshold. The outputs of the comparators 1902 to 1908 are connected to the AND circuit 308.

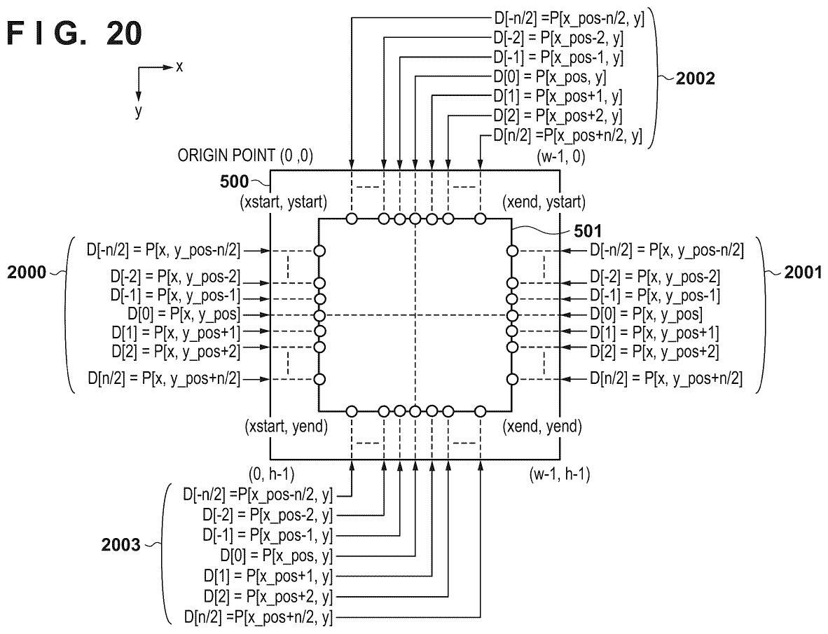

Next, the operation of the region detection device 103 of this embodiment will be described with reference to FIG. 20. A description of components that may be the same as those shown in FIG. 5 will be omitted appropriately. Similar to the operation according to the above-described embodiment, the memory control unit 301 is provided with the information (w, h) of the width and height of the inspection image 500. In this example, as illustrated in the flowchart shown in FIG. 11, the coordinates of the respective sides forming the outer edge of the display region 501 are detected in the order of the coordinate positions xstart, xend, ystart, and yend. In addition, the settings x_pos and y_pos are set in the central image in the vertical direction and the horizontal direction of the inspection image 500.

Plural lines 2000 are (n+1) lines to be scanned to detect the coordinate position xstart of the left side forming the outer edge of the display region 501. Similarly, plural lines 2001, plural lines 2002, or plural lines 2003 are (n+1) lines to be scanned to detect the coordinate position xend of the right side, the coordinate position ystart of the upper side, or the coordinate position yend of the lower side forming the outer edge of the display region 501.

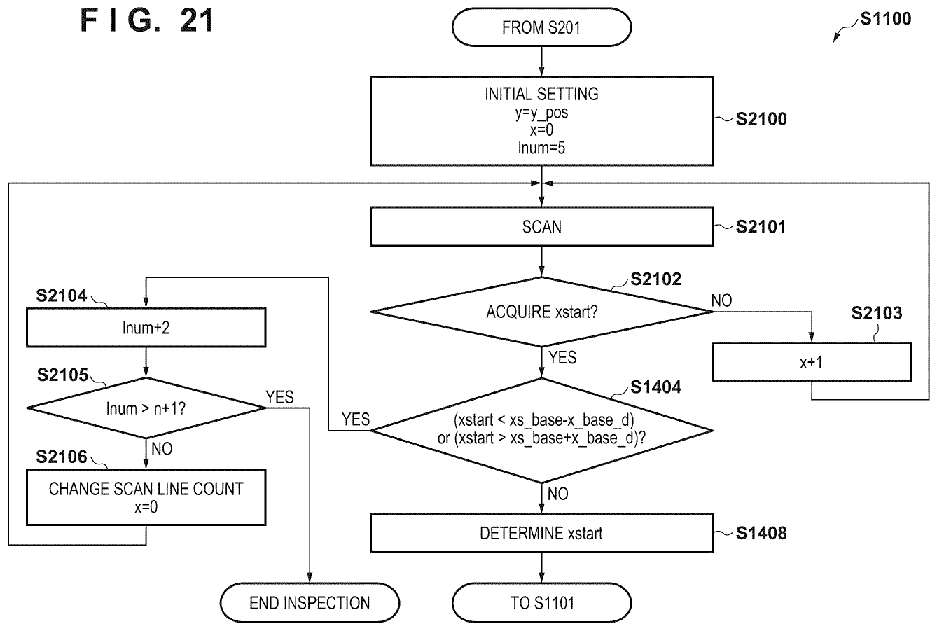

First, the detection of the coordinate position xstart of the left side forming the outer edge of the display region 501, which is shown in step S1100 of FIG. 11 and performed by the region detection device 103, will be described. FIG. 21 is a detailed flowchart illustrating the processing in step S1100.

When the process transitions from step S201 to step S2100 (S1100), a position at which scanning of the plural lines 2000 is started is set. With the setting y_pos, the y-coordinate of D[0] indicating the central line of the plural lines 2000 to be scanned is set to y_pos. In addition, the x-direction counter indicating a position in the x direction in the memory control unit 301 is set to 0, and a scan line count counter lnum is set to 5.

Next, in each step from step S2101, scanning is performed from the left end of the inspection image 500 in the +x direction. More specifically, image data P[x, y_pos−2], P[x, y_pos−1], P[x, y_pos], P[x, y_pos+1], and P[x, y_pos+2] for five lines indicated by the value of the scan line count counter lnum are read out from the image memory 102 via the memory control unit 301. The image data P are input to the comparators 1903 to 1907 via D[−2], D[−1], D[0], D[1], and D[2], respectively. Each of the image data P is compared with the threshold set in each of the comparators 1903 to 1907, and the comparison results are input to the AND circuit 308. At this time, the output (D[−n/2], D[+n/2], or the like) from the memory control unit 301 of a line that is not a scan target is larger than the set threshold value, and the output of the connected comparator is “1”. For example, the memory control unit 301 may supply the maximum value (8′hFF in the case of 8 bits) of the memory data to a line that is not a scan target.

Next, in step S2102, it is determined whether the coordinate position xstart is acquired. More specifically, it is determined whether the AND circuit 308 outputs “1” (all the outputs of the comparators 1902 to 1908 are “1” (all the pixel values are equal to or larger than the threshold)). If the output of the AND circuit 308 is not “1”, the x-direction counter is incremented by +1 in step S2103. The process returns to step S2101, and it is determined whether the AND circuit 308 outputs “1” in the next pixel in the +x direction. On the other hand, if the output of the AND circuit 308 is “1”, the process advances to step S1404.

In step S1404, the address determination unit 1209 determines whether the coordinate position xstart falls within the range of the effective coordinate region preset by the settings xs_base and x_base_d. More specifically, it is determined whether the coordinate position xstart falls within the range of xs_base±x_base_d. If the coordinate position xstart is larger than xs_base+x_base_d or smaller than xs_base-x_base_d (YES in step S1404), the coordinate position xstart falls outside the range of the effective coordinate region, and thus the process advances to step S2104.

In step S2104, the memory control unit 301 is notified of the rescan by the signal 1208, and the scan line count counter lnum is incremented by +2 to increase the number of lines to be scanned. That is, the number of lines which the memory control unit 301 reads out from the image memory 102 is increased. However, if it is determined in step S2105 that the value of the scan line count counter lnum is larger than the maximum number (n+1) of lines that the memory control unit 301 can read out (YES in step S2105), it is determined that the inspection image 500 is defective. That is, it is determined that the coordinate position xstart cannot be detected, the address determination unit 1209 outputs the interruption notification abort, and the defect inspection apparatus 100 ends the inspection. Alternatively, if the value of the scan line count counter lnum is equal to or smaller than the maximum number (n+1) of lines that the memory control unit 301 can read out, the process advances to step S2106.

In step S2106, the memory control unit 301 increases the number of lines to be scanned. In this case, the region detection device 103 increases the number of lines of the plural lines so that the range within which the plural lines are arranged in the direction along the detection target side becomes wider than that before the number of lines is increased. More specifically, the memory control unit 301 reads out the image data of the lines arranged outside before the number of lines is increased. Furthermore, the x-direction counter is reset to “0” by the signal 1208. After that, the process returns to step S2101, and the above-described steps are repeated.

If it is determined in step S1404 that the coordinate position xstart falls within the range of xs_base±x_base_d (NO in step S1404), the coordinate position xstart falls within the range of the effective coordinate region, and is thus confirmed (step S1408). In other words, it is determined that the coordinate position xstart is detected. In this case, the signal 1218 is output from the address determination unit 1209 to the coordinate acquisition unit 309 to store the coordinate position xstart. The signal 1218 is also supplied to the memory control unit 301, and the memory control unit 301 shifts to a step of detecting the coordinate position xend in step S1101.

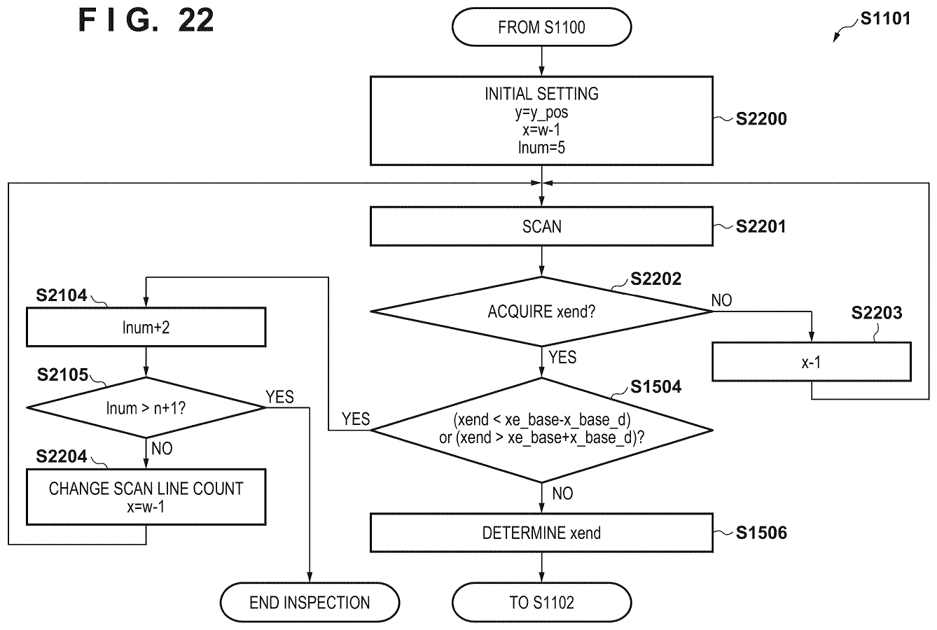

Next, the detection of the coordinate position xend of the right side forming the outer edge of the display region 501, which is shown in step S1101 of FIG. 11 and performed by the region detection device 103, will be described. FIG. 22 is a detailed flowchart illustrating the processing in step S1101. A description of the same steps as in the detection procedure of the coordinate position xstart described with reference to FIG. 21 will be omitted appropriately.

When the process transitions from step S1408 (S1100) to step S2200 (S1101), a position at which scanning of the plural lines 2001 is started is set. With the setting y_pos, the y-coordinate of D[0] indicating the central line of the plural lines 2001 to be scanned is set to y_pos. In addition, the x-direction counter indicating a position in the x direction in the memory control unit 301 is set to w−1, and the scan line count counter lnum is set to 5.

Next, in each step from step S2201, scanning is performed from the right end of the inspection image 500 in the −x direction. More specifically, the image data P[x, y_pos−2], P[x, y_pos−1], P[x, y_pos], P[x, y_pos+1], and P[x, y_pos+2] for five lines indicated by the value of the scan line count counter lnum are read out from the image memory 102 via the memory control unit 301. The image data P are input to the comparators 1903 to 1907 via D[−2], D[−1], D[0], D[1], and D[2], respectively. Each of the image data P is compared with the threshold set in each of the comparators 1903 to 1907, and the comparison results are input to the AND circuit 308. At this time, the output (D[−n/2], D[+n/2], or the like) from the memory control unit 301 of a line that is not a scan target is larger than the set threshold value, and the output of the connected comparator is “1”.

Next, in step S2202, it is determined whether the coordinate position xend is acquired. More specifically, it is determined whether the AND circuit 308 outputs “1” (all the outputs of the comparators 1902 to 1908 are “1” (all the pixel values are equal to or larger than the threshold)). If the output of the AND circuit 308 is not “1”, the x-direction counter is decremented by −1 in step S2203. The process returns to step S2201, and it is determined whether the AND circuit 308 outputs “1” in the next pixel in the −x direction. On the other hand, if the output of the AND circuit 308 is “1”, the process advances to step S1504.

In step S1504, the address determination unit 1209 determines whether the coordinate position xend falls within the range of the effective coordinate region preset by the settings xe_base and x_base_d. More specifically, it is determined whether the coordinate position xend falls within the range of xe_base±x_base_d. If the coordinate position xend is larger than xe_base+x_base_d or smaller than xe_base−x_base_d (YES in step S1504), the coordinate position xend falls outside the range of the effective coordinate region, and thus the process advances to steps S2104 and S2105.

Steps S2104 and S2105 are the same as those in the above-described detection procedure of the coordinate position xstart and a description thereof will be omitted. If the process transitions from step S2105 to step S2204, the memory control unit 301 increases, in step S2204, the number of lines to be scanned. Furthermore, the x-direction counter is reset to “w−1” by the signal 1208. After that, the process returns to step S2201, and the above-described steps are repeated.

If it is determined in step S1504 that the coordinate position xend falls within the range of xe_base±x_base_d (NO in step S1504), the coordinate position xend falls within the range of the effective coordinate region, and is thus confirmed (step S1506). In other words, it is determined that the coordinate position xend is detected. In this case, the signal 1218 is output from the address determination unit 1209 to the coordinate acquisition unit 309 to store the coordinate position xend. The signal 1218 is also supplied to the memory control unit 301, and the memory control unit 301 shifts to a step of detecting the coordinate position ystart in step S1102.

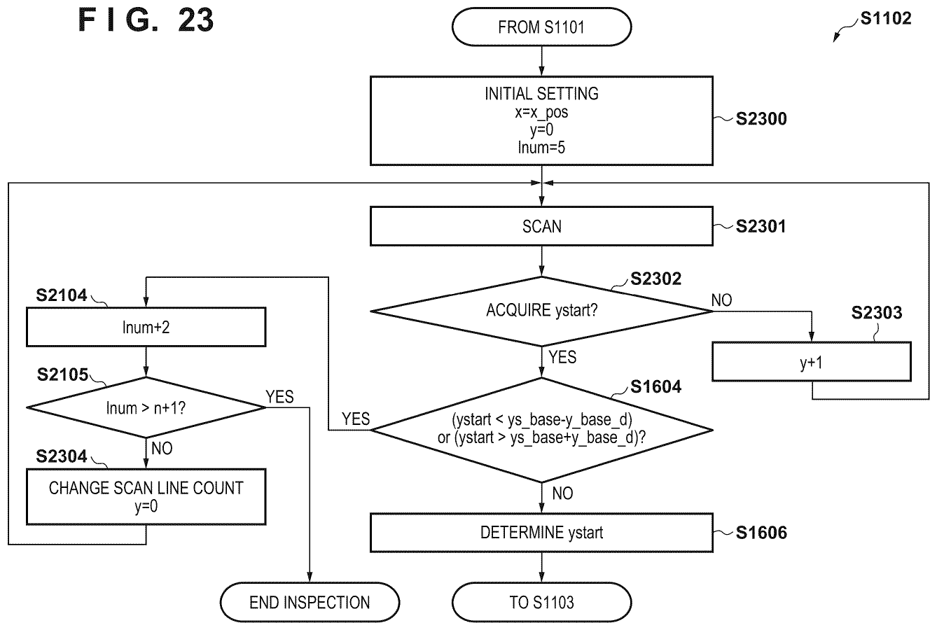

Next, the detection of the coordinate position ystart of the upper side forming the outer edge of the display region 501, which is shown in step S1102 of FIG. 11 and performed by the region detection device 103, will be described. FIG. 23 is a detailed flowchart illustrating the processing in step S1102. A description of the same steps as in the detection procedures of the coordinate positions xstart and xend described with reference to FIGS. 21 and 22 will be omitted appropriately.

When the process transitions from step S1506 (S1101) to step S2300 (S1102), a position at which scanning of the plural lines 2002 is started is set. With the setting x_pos, the x-coordinate of D[0] indicating the central line of the plural lines 2002 to be scanned is set to x_pos. In addition, the y-direction counter indicating a position in the y direction in the memory control unit 301 is set to 0, and the scan line count counter lnum is set to 5.

Next, in each step from step S2301, scanning is performed from the upper end of the inspection image 500 in the +y direction. More specifically, image data P[x_pos−2, y], P[x_pos−1, y], P[x_pos, y], P[x_pos+1, y], and P[x_pos+2, y] for five lines indicated by the value of the scan line count counter lnum are read out from the image memory 102 via the memory control unit 301. The image data P are input to the comparators 1903 to 1907 via D[−2], D[−1], D[0], D[1], and D[2], respectively. Each of the image data P is compared with the threshold set in each of the comparators 1903 to 1907, and the comparison results are input to the AND circuit 308. At this time, the output (D[−n/2], D[+n/2], or the like) from the memory control unit 301 of a line that is not a scan target is larger than the set threshold value, and the output of the connected comparator is “1”.

Next, in step S2302, it is determined whether the coordinate position ystart is acquired. More specifically, it is determined whether the AND circuit 308 outputs “1” (all the outputs of the comparators 1902 to 1908 are “1” (all the pixel values are equal to or larger than the threshold)). If the output of the AND circuit 308 is not “1”, the y-direction counter is incremented by +1 in step S2303. The process returns to step S2301, and it is determined whether the AND circuit 308 outputs “1” in the next pixel in the +y direction. On the other hand, if the output of the AND circuit 308 is “1”, the process advances to step S1604.

In step S1604, the address determination unit 1209 determines whether the coordinate position ystart falls within the range of the effective coordinate region preset by the settings ys_base and y_base_d. More specifically, it is determined whether the coordinate position ystart falls within the range of ys_base±y_base_d. If the coordinate position ystart is larger than ys_base+y_base_d or smaller than ys_base-y_base_d (YES in step S1604), the coordinate position ystart falls outside the range of the effective coordinate region, and thus the process advances to steps S2104 and S2105.

Steps S2104 and S2105 are the same as those in the above-described detection procedures of the coordinate positions xstart and xend and a description thereof will be omitted. If the process transitions from step S2105 to step S2304, the memory control unit 301 increases, in step S2304, the number of lines to be scanned. Furthermore, the y-direction counter is reset to “0” by the signal 1208. After that, the process returns to step S2301, and the above-described steps are repeated.

If it is determined in step S1604 that the coordinate position ystart falls within the range of ys_base±y_base_d (NO in step S1604), the coordinate position ystart falls within the range of the effective coordinate region, and is thus confirmed (step S1606). In other words, it is determined that the coordinate position ystart is detected. In this case, the signal 1218 is output from the address determination unit 1209 to the coordinate acquisition unit 309 to store the coordinate position ystart. The signal 1218 is also supplied to the memory control unit 301, and the memory control unit 301 shifts to a step of detecting the coordinate position yend in step S1103.

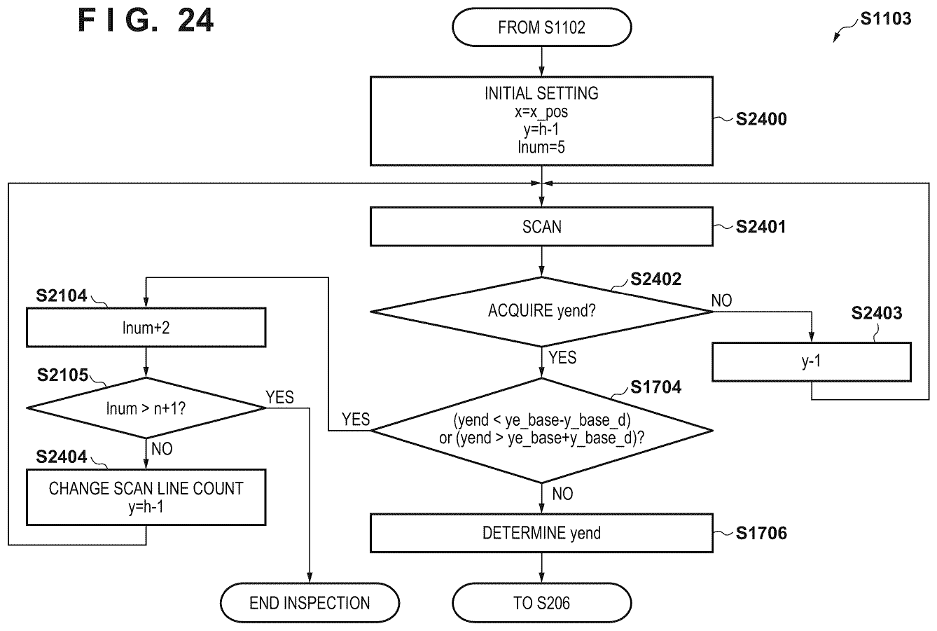

Next, the detection of the coordinate position yend of the lower side forming the outer edge of the display region 501, which is shown in step S1103 of FIG. 11 and performed by the region detection device 103, will be described. FIG. 24 is a detailed flowchart illustrating the processing in step S1103. A description of the same steps as in the detection procedures of the coordinate positions xstart, xend, and ystart described with reference to FIGS. 21 to 23 will be omitted appropriately.

When the process transitions from step S1606 (S1102) to step S2400 (S1103), a position at which scanning of the plural lines 2003 is started is set. With the setting x_pos, the x-coordinate of D[0] indicating the central line of the plural lines 2003 to be scanned is set to x_pos. In addition, the y-direction counter indicating a position in the y direction in the memory control unit 301 is set to h−1, and the scan line count counter lnum is set to 5.

Next, in each step from step S2401, scanning is performed from the lower end of the inspection image 500 in the −y direction. More specifically, the image data P[x_pos−2, y], P[x_pos−1, y], P[x_pos, y], P[x_pos+1, y], and P[x_pos+2, y] for five lines indicated by the value of the scan line count counter lnum are read out from the image memory 102 via the memory control unit 301. The image data P are input to the comparators 1903 to 1907 via D[−2], D[−1], D[0], D[1], and D[2], respectively. Each of the image data P is compared with the threshold set in each of the comparators 1903 to 1907, and the comparison results are input to the AND circuit 308. At this time, the output (D[−n/2], D[+n/2], or the like) from the memory control unit 301 of a line that is not a scan target is larger than the set threshold value, and the output of the connected comparator is “1”.

Next, in step S2402, it is determined whether the coordinate position yend is acquired. More specifically, it is determined whether the AND circuit 308 outputs “1” (all the outputs of the comparators 1902 to 1908 are “1” (all the pixel values are equal to or larger than the threshold)). If the output of the AND circuit 308 is not “1”, the y-direction counter is decremented by −1 in step S2403. The process returns to step S2401, and it is determined whether the AND circuit 308 outputs “1” in the next pixel in the −y direction. On the other hand, if the output of the AND circuit 308 is “1”, the process advances to step S1704.

In step S1704, the address determination unit 1209 determines whether the coordinate position yend falls within the range of the effective coordinate region preset by the settings ye_base and y_base_d. More specifically, it is determined whether the coordinate position yend falls within the range of ye_base±y_base_d. If the coordinate position yend is larger than ye_base+y_base_d or smaller than ye_base−y_base_d (YES in step S1704), the coordinate position yend falls outside the range of the effective coordinate region, and thus the process advances to steps S2104 and S2105.

Steps S2104 and S2105 are the same as those in the above-described detection procedures of the coordinate positions xstart, xend, and ystart and a description thereof will be omitted. If the process transitions from step S2105 to step S2404, the memory control unit 301 increases, in step S2404, the number of lines to be scanned. Furthermore, the y-direction counter is reset to “h−1” by the signal 1208. After that, the process returns to step S2401, and the above-described steps are repeated.

If it is determined in step S1704 that the coordinate position yend falls within the range of ye_base±y_base_d (NO in step S1704), the coordinate position yend falls within the range of the effective coordinate region, and is thus confirmed (step S1706). In other words, it is determined that the coordinate position yend is detected. In this case, the signal 1218 is output from the address determination unit 1209 to the coordinate acquisition unit 309 to store the coordinate position yend. The signal 1218 is also supplied to the memory control unit 301, thereby ending the steps of detecting the sides forming the outer edge of the display region 501.

After the coordinate positions xstart, ystart, xend, and yend are detected, the detected coordinate positions xstart, ystart, xend, and yend of the respective sides of the display region 501 are output from the region detection device 103 to the defect inspection device 105 in step S206. For example, the region detection device 103 may supply, to the defect inspection device 105, the values of the coordinate positions xstart, xend, ystart, and yend corresponding to the respective sides forming the outer edge of the display region 501. Alternatively, for example, the region detection device 103 may supply the coordinates (xstart, ystart), (xend, ystart), (xstart, yend), and (xend, yend) of the four corners of the display region 501 to the defect inspection device 105. Next, in step S207, the defect inspection device 105 performs an operation for detecting a defect of the display region 501 specified by the region detection device 103.

As described above, when the region detection device 103 detects the coordinate position of each side forming the outer edge of the display region 501, it is determined whether the coordinate position is an appropriate position. If the coordinate position is not an appropriate position, the number of lines to be scanned is changed to perform scanning again. Thus, it is possible to detect the display region 501 of the display device 107 more reliably. In addition, if the number of lines to be read out of the image data P from the image memory 102 is increased, the processing time also increases. To cope with this, scanning is started from the number of lines (for example, five lines) assumed to be slightly larger than the one defect 400, 800, or 801 caused by the sensor panel of the image acquisition device 101 or the like, and scanning is performed again by increasing the number of lines to be scanned by two. This can minimize an increase in processing time. Similar to the configuration described with reference to FIGS. 10 to 17, it is possible to detect the defective inspection image 500 before inspection by the defect inspection device 105. As described above, since it takes time to perform inspection by the defect inspection device 105, fail-stop to end inspection is enabled before inspection by the defect inspection device 105. This can shorten the inspection time of the whole inspection target lot such as the plurality of display devices 107. This embodiment has explained an example in which the number of lines to be scanned is increased by two in a case where the coordinate position is not an appropriate position, but the number of lines to be scanned may be increased by one or three or more.

In the above-described embodiment, the four coordinate positions are detected in the order of the coordinate positions xstart, xend, ystart, and yend but can be detected in an arbitrary order. As the threshold supplied to each of the comparators 302 to 306 or the comparators 1902 to 1908, an appropriate value may be set based on the light emission state of the display region 501 of each display device 107 or may be decided based on the light emission states of the display regions 501 of the plurality of display devices 107. For example, a value of a level lower than the average value of luminance values extracted from the display regions 501 of the plurality of display devices 107 may be set as the threshold.

As described above, the region detection device 103 according to this embodiment is difficult to be influenced by the defect caused by the sensor panel of the image acquisition device 101 or the like. Therefore, the defect inspection apparatus 100 including the region detection device 103 according to this embodiment can accurately extract the display region 501 of the display device 107 and inspect a defect of the display region 501.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A region detection device for detecting a display region of a display device from an inspection image captured in a state in which the display region is lighted, wherein
the region detection device is configured to:
scan plural lines set to intersect a side forming an outer edge of the display region; and
specify the display region by detecting a coordinate position of each side based on a pixel value of a pixel of each of the plural lines, and
in the scanning of the plural lines, the region detection device is configured to:
compare each of the pixel values of the pixels included in the plural lines with a threshold; and
detect, as the coordinate position, a position in a scanning direction at which all the pixel values of the plural lines change from values smaller than the threshold to values not smaller than the threshold.

2. The device according to claim 1, wherein the region detection device is configured to scan the plural lines from an outside of the display region to the display region in the inspection image.

3. The device according to claim 1, wherein the region detection device is configured to scan the plural lines from a pixel arranged in an edge portion of the inspection image to the display region.

4. The device according to claim 1, wherein the threshold is set in accordance with a pixel value of a pixel arranged in a central portion of the inspection image.

5. The device according to claim 1, wherein the threshold is set in accordance with pixel values of pixels arranged in central portions of a plurality of inspection images including the inspection image.

6. The device according to claim 1, wherein in a case where the detected coordinate position falls outside a preset range, the region detection device is configured to shift positions of the plural lines in a direction along the side, and performs scanning of the plural lines again.

7. The device according to claim 6, wherein, in a case when the detected coordinate position falls outside the preset range, the region detection device is configured to repeat the shift of the positions of the plural lines and the scanning of the plural lines, and, in a case when the coordinate position falls outside the preset range after repeating a predetermined number of times, the region detection device is configured to abort the scanning of the plural lines.

8. The device according to claim 1, wherein, in a case when the detected coordinate position falls outside a preset range, the region detection device is configured to increase a number of lines of the plural lines, and performs scanning of the plural lines again.

9. The device according to claim 8, wherein, in a case when the detected coordinate position falls outside the preset range, the region detection device is configured to increase the number of lines of the plural lines so that a range within which the plural lines are arranged in a direction along the side becomes wider than a range before the number of lines is increased.

10. The device according to claim 8, wherein, in a case when the detected coordinate position falls outside the preset range, the region detection device is configured to repeat the increase of the number of lines of the plural lines and the scanning of the plural lines, and,
in a case when the detected coordinate position falls outside the preset range until a predetermined number of lines is reached, the region detection device is configured to abort the scanning of the plural lines.

11. The device according to claim 1, wherein the display region is rectangle, and
the region detection device is configured to scan the plural lines set for each of four sides forming the outer edge.

12. The device according to claim 1, wherein the plural lines include a first line and a second line, and
the first line and the second line are formed by pixels arranged to be adjacent to each other in a direction along the side.

13. The device according to claim 1, wherein the plural lines include a first line and a second line arranged to be adjacent to each other, and
a pixel not forming the plural lines is arranged between the first line and the second line in a direction along the side.

14. The device according to claim 1, wherein a central pixel of the inspection image in a direction along the side is arranged within a range in which the plural lines are arranged in the direction along the side.

15. The device according to claim 14, wherein a central line of the plural lines is formed by the central pixel.

16. The device according to claim 1, wherein a central line of the plural lines is selected in accordance with pixel values of the display region.

17. A defect inspection apparatus comprising:
the region detection device according to claim 1;
an image acquisition device configured to acquire an inspection image; and
a defect inspection device configured to inspect a defect of a display region specified by the region detection device.

18. The apparatus according to claim 17, further comprising a memory configured to store a size of a defect appearing in the inspection image in accordance with a characteristic of the image acquisition device,
wherein a range in which the plural lines are arranged in a direction along a side is set to be larger than the size of the defect stored in the memory.
